(19) United States
(12) Patent Application Publication
(10) Pub. No.: US 2024/0302321 A1
(43) Pub. Date: Sep. 12, 2024

(54) GAS SENSOR CONTROL DEVICE, GAS SENSOR CONTROL METHOD, AND GAS SENSOR CONTROL SYSTEM

(71) Applicant: Niterra Co., Ltd., Nagoya-shi, Aichi (JP)

(72) Inventors: Hiroyuki TANAKA, Nagoya-shi (JP); Tetsuya ITO, Nagoya-shi (JP)

(21) Appl. No.: 18/574,376

(22) PCT Filed: Jun. 14, 2022
(86) PCT No.: PCT/JP2022/023777

§ 371 Date: Dec. 27, 2023

(30) Foreign Application Priority Data
Jul. 30, 2021 (JP) 2021-125178

(51) Int. Cl. G01N 27/41; F01N 11/00

(52) U.S. Cl. CPC G01N 27/41; F01N 11/007

(57) ABSTRACT

A gas sensor control device controls a gas sensor including a first pumping cell and a second pumping cell configured to output a current in accordance with a concentration of a specific component in a measurement target gas. The gas sensor control device has a microprocessor configured to, when calculating the concentration of the specific component, use a correction expression based on an index including at least either an initial offset indicating a current value when the concentration of the specific component at a first reference time is 0 or a difference between an ideal value and the current value when the concentration of the specific component at a second reference time is a set concentration, and a cumulative operating time which is a total operating time of the gas sensor from a third reference time.

### TECHNICAL FIELD

The present invention relates to a gas sensor control device, a gas sensor control method, and a gas sensor control system.

### BACKGROUND ART

A gas sensor control device disclosed in Patent Document 1 controls a gas sensor element including a pump cell and a sensor cell. The pump cell has a solid electrolyte body, a pump electrode disposed on a surface of the solid electrolyte body on a measurement chamber side, and a sensor electrode disposed on a surface of the solid electrolyte body on an air chamber side. In the pump cell, a current corresponding to the concentration of oxygen in exhaust flows between the electrodes. The sensor cell has a solid electrolyte body, a sensor electrode disposed on a surface of the solid electrolyte body on the measurement chamber side, and a common electrode. In the sensor cell, a current (sensor current) corresponding to the concentration of NOx and the concentration of residual oxygen in the exhaust flows between the electrodes. The gas sensor control device calculates a correction coefficient on the basis of the atmospheric pressure and the concentration of the oxygen in the exhaust detected by the pump cell. The gas sensor control device calculates an output ratio as a rate of change from the initial stage of the sensor current. The gas sensor control device is configured to multiply the output ratio by the correction coefficient, thereby correcting the output ratio to be used for deterioration diagnosis.

### PRIOR ART DOCUMENT

### Patent Document

Patent Document 1: Japanese Patent Application Laid-Open (kokai) No. 2020-122741

### SUMMARY OF THE INVENTION

### Problem to be Solved by the Invention

As in the gas sensor control device of Patent Document 1, there is known a configuration of performing deterioration determination of a gas sensor on the basis of output from the gas sensor having detected a specific component in a measurement target gas (an output ratio in which the concentration of the specific component is reflected). However, with such a configuration, the output itself from the gas sensor is not corrected, and it is difficult to perform accurate concentration measurement. Therefore, a configuration capable of calculating the concentration of a specific component in a measurement target gas such that the deterioration state of a gas sensor is reflected therein, is required.

An object of the present invention is to provide a technology capable of calculating the concentration of a specific component in a measurement target gas such that the deterioration state of a gas sensor is reflected therein.

### Means for Solving the Problem

The features of [1] to [9] exemplified below may be combined in any manner as long as the combination is not contradictory.

[1] A gas sensor control device of the present invention is a gas sensor control device for controlling a gas sensor having therein a measurement chamber to which an external measurement target gas is introduced, the gas sensor including a first pumping cell configured to perform pumping-out and pumping-in of oxygen with respect to the measurement target gas in the measurement chamber, and a second pumping cell having a pair of electrodes disposed inside and outside the measurement chamber, respectively, and configured to output a current between the pair of electrodes in accordance with a concentration of a specific component in the measurement target gas that has been introduced into the measurement chamber and on which the pumping-out and the pumping-in of oxygen have been performed, the gas sensor control device including a calculation unit configured to calculate the concentration of the specific component from a current value which is a magnitude of the current. When calculating the concentration of the specific component, the calculation unit performs correction on the basis of an index including at least either an initial offset indicating the current value when the concentration of the specific component at a first reference time is 0 or a difference between an ideal value and the current value when the concentration of the specific component at a second reference time is a set concentration, and a cumulative operating time which is a total operating time of the gas sensor from a third reference time.

With such a configuration, the gas concentration of the specific component in the measurement target gas can be calculated such that an index in which the deterioration state of the gas sensor is reflected (index including at least either the initial offset or the difference) and the cumulative operating time are reflected to the current outputted in accordance with the concentration of the specific component in the measurement target gas. Therefore, the concentration of the specific component in the measurement target gas can be calculated such that the deterioration state of the gas sensor is reflected therein.

[2] Preferably, when the current value is in a predetermined high-current state, the calculation unit calculates the concentration of the specific component using the difference as the index, and when the current value is in a predetermined low-current state, the calculation unit calculates the concentration of the specific component using the initial offset as the index.

With such a configuration, when the concentration of the specific component in the measurement target gas is relatively high (in the case of a predetermined high-current state), the concentration of the specific component can be corrected such that the difference is reflected therein. On the other hand, when the concentration of the specific component is relatively low (in the case of a predetermined low-current state), the concentration of the specific component can be corrected such that the initial offset is reflected therein.

[3] Preferably, the gas sensor control device further includes a storage unit configured to divide the cumulative operating time into a plurality of predetermined time segments, divide the current value into a plurality of predetermined current value segments, divide a concentration of the specific component corresponding to the current value into a plurality of predetermined concentration segments, and store a plurality of patterns of a linear expression with the initial offset or the difference as a variable in association with at least one of the predetermined time segments, the predetermined current value segments, or the predetermined concentration segments, and the calculation unit selects the linear expression stored in the storage unit, on the basis of at least one of the predetermined time segments, the predetermined current value segments, or the predetermined concentration segments, and calculates the concentration of the specific component on the basis of the current value and the linear expression selected from among the plurality of patterns stored in the storage unit and corresponding to the cumulative operating time, the current value, or a concentration corresponding to the current value.

With such a configuration, the linear expression with the initial offset or the difference as a variable can be selected in accordance with at least one of the cumulative operating time, the current value, or the concentration corresponding to the current value. Therefore, the concentration of the specific component in the measurement target gas can be corrected using an appropriate linear expression corresponding to at least one of the cumulative operating time, the current value, or the concentration corresponding to the current value.

[4] Preferably, the gas sensor control device further includes a storage unit configured to divide the cumulative operating time into a plurality of predetermined time segments, divide the current value into a plurality of predetermined current value segments, divide a concentration of the specific component corresponding to the current value into a plurality of predetermined concentration segments, and store a plurality of patterns of a linear expression with the initial offset or the difference as a variable in association with at least one of the predetermined time segments, the predetermined current value segments, or the predetermined concentration segments The storage unit stores a quadratic expression defined with a time as a variable, as each of a gradient and an intercept of the linear expression, and the calculation unit calculates the concentration of the specific component on the basis of the current value and the quadratic expression defined with the cumulative operating time.

With such a configuration, each of an appropriate gradient and an appropriate intercept corresponding to the cumulative operating time can be obtained by using the cumulative operating time as the variable of the quadratic expression. The concentration of the specific component in the measurement target gas can be corrected by using the linear expression including such an appropriate gradient and such an appropriate intercept corresponding to the cumulative operating time.

[5] Preferably, the gas sensor control device further includes a storage unit configured to store a linear expression with the index at a predetermined reference time as a variable, and the calculation unit calculates the concentration of the specific component on the basis of the linear expression and a ratio of the cumulative operating time to the predetermined reference time.

With such a configuration, the concentration of NOx in the measurement target gas can be corrected such that the ratio of the cumulative operating time to the predetermined reference time is reflected therein.

[6] A gas sensor control method of the present invention is a gas sensor control method for controlling a gas sensor having therein a measurement chamber to which an external measurement target gas is introduced, the gas sensor including a first pumping cell configured to perform pumping-out and pumping-in of oxygen with respect to the measurement target gas in the measurement chamber, and a second pumping cell having a pair of electrodes disposed inside and outside the measurement chamber, respectively, and configured to output a current between the pair of electrodes in accordance with a concentration of a specific component in the measurement target gas that has been introduced into the measurement chamber and on which the pumping-out and the pumping-in of oxygen have been performed. The gas sensor control method includes, when calculating the concentration of the specific component from a current value which is a magnitude of the current, performing correction on the basis of an index including at least either an initial offset indicating the current value when the concentration of the specific component at a first reference time is 0 or a difference between an ideal value and the current value when the concentration of the specific component at a second reference time is a set concentration, and a cumulative operating time which is a total operating time of the gas sensor from a third reference time.

With such a configuration, the gas concentration of the specific component in the measurement target gas can be calculated such that an index in which the deterioration state of the gas sensor is reflected (index including at least either the initial offset or the difference) and the cumulative operating time are reflected to the current outputted in accordance with the concentration of the specific component in the measurement target gas. Therefore, the concentration of the specific component in the measurement target gas can be calculated such that the deterioration state of the gas sensor is reflected therein.

[7] A gas sensor control system of the present invention includes the gas sensor control device in any one of [1] to [5], and the gas sensor.

With such a configuration, the same advantageous effects as those of the gas sensor control devices in [1] to [5] can be achieved.

[8] Preferably, the measurement target gas is an exhaust gas discharged from an internal combustion engine to which an exhaust gas purifying device configured to purify an exhaust gas is attached, the gas sensor detects the concentration of the specific component on an upstream side with respect to the exhaust gas purifying device, and the calculation unit calculates the concentration of the specific component using the difference as the index.

With such a configuration, since the gas sensor is configured to detect the concentration of the specific component on the upstream side with respect to the exhaust gas purifying device, the concentration of the specific gas is detected as a relatively high concentration. When the concentration of the specific gas is detected as a relatively high concentration as described above, the concentration of the specific component in the measurement target gas can be corrected such that the difference (difference between the ideal value and the current value when the concentration of the specific component at the second reference time is the set concentration) is reflected therein.

[9] Preferably, the measurement target gas is an exhaust gas discharged from an internal combustion engine to which an exhaust gas purifying device configured to purify an exhaust gas is attached, the gas sensor detects the concentration of the specific component on a downstream side with respect to the exhaust gas purifying device, and the calculation unit calculates the concentration of the specific component using the initial offset as the index.

With such a configuration, since the gas sensor is configured to detect the concentration of the specific component on the downstream side with respect to the exhaust gas purifying device, the concentration of the specific gas is detected as a relatively low concentration. When the concentration of the specific gas is detected as a relatively low concentration as described above, the concentration of the specific component in the measurement target gas can be corrected such that the initial offset is reflected therein.

### Advantageous Effects of the Invention

According to the present invention, the concentration of the specific component in the measurement target gas can be calculated such that the deterioration state of the gas sensor is reflected therein.

### BRIEF DESCRIPTION OF THE DRAWINGS

FIG. 1 is an explanatory diagram showing a schematic configuration of a gas sensor system according to a first embodiment.

FIG. 2 is an explanatory diagram illustrating an arrangement configuration of a NOx sensor in FIG. 1.

FIG. 3 is a flowchart illustrating the flow of control performed by a control device in FIG. 1.

FIG. 4 is a flowchart illustrating the flow of control following the flowchart in FIG. 3.

FIG. 5 is a flowchart illustrating the flow of control following the flowchart in FIG. 4.

FIG. 6 is a flowchart illustrating the flow of control following the flowchart in FIG. 5.

FIG. 7 is a flowchart illustrating the flow of control following the flowchart in FIG. 6.

FIG. 8 is an explanatory diagram schematically showing a relationship between a NOx concentration and Ip2 for describing an offset.

FIG. 9 is an explanatory diagram schematically showing a relationship between a NOx concentration and Ip2 for describing an Ip2 decrease ratio.

FIG. 10 is an explanatory diagram illustrating gradients and intercepts, at each NOx concentration and each cumulative operating time, stored in a microprocessor.

FIG. 11 is an explanatory diagram showing a correlation between an initial offset and ΔIp2 when a NOx concentration is 0 ppm and a cumulative operating time is 300 hours.

FIG. 12 is an explanatory diagram showing a correlation between an initial offset and ΔIp2 when a NOx concentration is 0 ppm and a cumulative operating time is 1000 hours.

FIG. 13 is an explanatory diagram showing a correlation between an initial offset and ΔIp2 when a NOx concentration is 0 ppm and a cumulative operating time is 2000 hours.

FIG. 14 is an explanatory diagram showing a correlation between an initial offset and ΔIp2 when a NOx concentration is 0 ppm and a cumulative operating time is 3750 hours.

FIG. 15 is an explanatory diagram showing a correlation between an initial offset and ΔIp2 when a NOx concentration is 90 ppm and a cumulative operating time is 300 hours.

FIG. 16 is an explanatory diagram showing a correlation between an initial offset and ΔIp2 when a NOx concentration is 90 ppm and a cumulative operating time is 1000 hours.

FIG. 17 is an explanatory diagram showing a correlation between an initial offset and ΔIp2 when a NOx concentration is 90 ppm and a cumulative operating time is 2000 hours.

FIG. 18 is an explanatory diagram showing a correlation between an initial offset and ΔIp2 when a NOx concentration is 90 ppm and a cumulative operating time is 3750 hours.

FIG. 19 is an explanatory diagram showing a correlation between an initial offset and ΔIp2 when a NOx concentration is 1500 ppm and a cumulative operating time is 300 hours.

FIG. 20 is an explanatory diagram showing a correlation between an initial offset and ΔIp2 when a NOx concentration is 1500 ppm and a cumulative operating time is 1000 hours.

FIG. 21 is an explanatory diagram showing a correlation between an initial offset and ΔIp2 when a NOx concentration is 1500 ppm and a cumulative operating time is 2000 hours.

FIG. 22 is an explanatory diagram showing a correlation between an initial offset and ΔIp2 when a NOx concentration is 1500 ppm and a cumulative operating time is 3750 hours.

FIG. 23 is a flowchart illustrating the flow of control performed by a control device of a gas sensor system according to a second embodiment.

FIG. 24 is a flowchart illustrating the flow of control following the flowchart in FIG. 23.

FIG. 25 is a flowchart illustrating the flow of control following the flowchart in FIG. 24.

FIG. 26 is an explanatory diagram showing a correlation between a cumulative operating time and a gradient a of a linear function with an initial offset as a variable when a NOx concentration is 0 ppm.

FIG. 27 is an explanatory diagram showing a correlation between a cumulative operating time and an intercept b of a linear function with an initial offset as a variable when a NOx concentration is 0 ppm.

FIG. 28 is an explanatory diagram showing a correlation between a cumulative operating time and a gradient a of a linear function with an initial offset as a variable when a NOx concentration is 90 ppm.

FIG. 29 is an explanatory diagram showing a correlation between a cumulative operating time and an intercept b of a linear function with an initial offset as a variable when a NOx concentration is 90 ppm.

FIG. 30 is an explanatory diagram showing a correlation between a cumulative operating time and a gradient a of a linear function with an initial Ip2 decrease ratio as a variable when a NOx concentration is 1500 ppm.

FIG. 31 is an explanatory diagram showing a correlation between a cumulative operating time and an intercept b of a linear function with an initial Ip2 decrease ratio as a variable when a NOx concentration is 1500 ppm.

FIG. 32 is a flowchart illustrating the flow of control performed by a control device of a gas sensor system according to a third embodiment.

FIG. 33 is a flowchart illustrating the flow of control following the flowchart in FIG. 32.

### MODES FOR CARRYING OUT THE INVENTION

### 1. First Embodiment

### 1-1. Configuration of Gas Sensor System 1

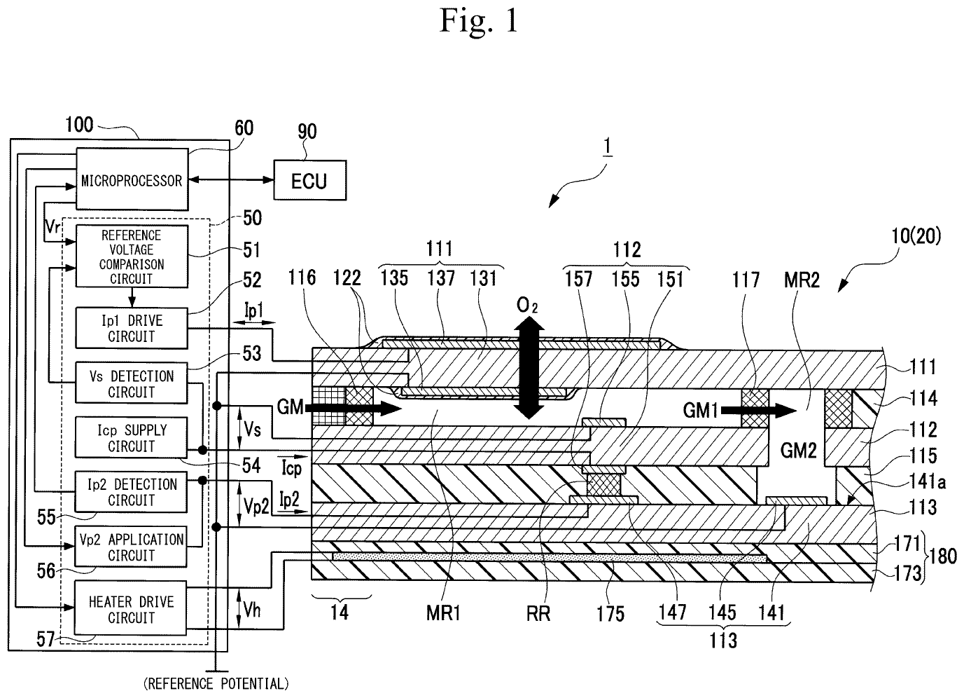

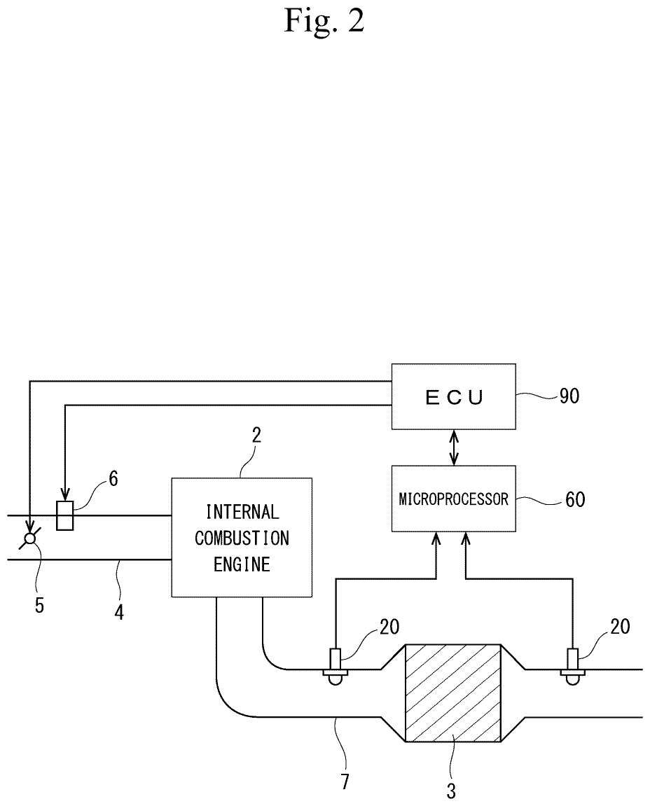

A gas sensor system 1 shown in FIG. 1 includes a gas sensor control device 100 and a NOx sensor 20. The gas sensor system 1 corresponds to an example of the “gas sensor control system” of the present invention. The NOx sensor 20 detects the concentration of a specific component (NOx) in a measurement target gas. The NOx sensor 20 corresponds to an example of the “gas sensor” of the present invention. The NOx sensor 20 has a NOx sensor element 10. The gas sensor control device 100 corresponds to an example of the “gas sensor control device” of the present invention. The gas sensor system 1 is mounted on a vehicle (not shown) including an internal combustion engine (hereinafter, also referred to as engine) 2 shown in FIG. 2, and detects the concentration of NOx in an exhaust gas GM (measurement target gas) of the engine by controlling the NOx sensor element 10 (NOx sensor 20) with the gas sensor control device 100. Among these components, the NOx sensor 20 includes the NOx sensor element 10 and a metal shell which is not shown and in which the NOx sensor element 10 is housed. A description will be given with the left side in FIG. 1 as a front side of the NOx sensor element 10 and the right side in FIG. 1 as a rear side of the NOx sensor element 10.

In the NOx sensor 20, for example, the measurement target gas is an exhaust gas discharged from the internal combustion engine 2 to which an exhaust gas purifying device 3 for purifying an exhaust gas is attached as shown in FIG. 2. On an intake pipe 4 of the internal combustion engine 2, a throttle valve 5 and an injector 6 are provided from the upstream side. The exhaust gas purifying device 3 is provided on an exhaust pipe 7 of the internal combustion engine 2. The exhaust gas purifying device 3 is configured, for example, as a NOx occlusion catalyst for adsorbing and removing NOx in an exhaust gas. The NOx sensor 20 is provided on each of the upstream side and the downstream side of the exhaust gas purifying device 3 on the exhaust pipe 7. The NOx sensor 20 on the upstream side detects the concentration of the specific component in the measurement target gas on the upstream side with respect to the exhaust gas purifying device 3. The NOx sensor 20 on the downstream side detects the concentration of the specific component in the measurement target gas on the downstream side with respect to the exhaust gas purifying device 3.

### 1-2. Configuration of NOx Sensor Element 10

The NOx sensor element 10 detects the concentration of NOx in the measurement target gas. The NOx sensor element 10 has a first pumping cell 111, an oxygen concentration detection cell 112, and a second pumping cell 113. The NOx sensor element 10 has a structure in which the first pumping cell 111, the oxygen concentration detection cell 112, and the second pumping cell 113 are stacked with insulation layers 114 and 115, which are mainly composed of alumina, interposed therebetween. Furthermore, on the second pumping cell 113 side of the NOx sensor element 10, a heater unit 180 is stacked.

The first pumping cell 111 includes a first solid electrolyte layer 131, a first-pump first electrode 135, and a first-pump second electrode 137. The first solid electrolyte layer 131 is composed of a solid electrolyte body mainly composed of zirconia. The first-pump first electrode 135 and the first-pump second electrode 137 are disposed such that the first solid electrolyte layer 131 is interposed therebetween. The first-pump first electrode 135 and the first-pump second electrode 137 are porous. The first-pump first electrode 135 is disposed so as to face a first measurement chamber MR1 described later. Each of the surfaces of the first-pump first electrode 135 and the first-pump second electrode 137 is covered with a protective layer 122 composed of a porous body.

The oxygen concentration detection cell 112 includes a third solid electrolyte layer 151, a detection electrode 155, and a reference electrode 157. The third solid electrolyte layer 151 is composed of a solid electrolyte body mainly composed of zirconia. The detection electrode 155 and the reference electrode 157 are disposed such that the third solid electrolyte layer 151 is interposed therebetween. The detection electrode 155 and the reference electrode 157 are porous.

The second pumping cell 113 includes a second solid electrolyte layer 141, a second-pump first electrode 145, and a second-pump second electrode 147. The second solid electrolyte layer 141 is composed of a solid electrolyte body mainly composed of zirconia. The second-pump first electrode 145 and the second-pump second electrode 147 are disposed on a surface 141a of the second solid electrolyte layer 141 on a side facing the insulation layer 115. The second-pump first electrode 145 and the second-pump second electrode 147 are disposed inside and outside a second measurement chamber MR2 described later, respectively. The second-pump first electrode 145 and the second-pump second electrode 147 are porous. The second pumping cell 113 is configured such that a pumping current (hereinafter, also referred to simply as current) corresponding to the concentration of the specific component (NOx) in the measurement target gas flows between the second-pump first electrode 145 and the second-pump second electrode 147.

The first measurement chamber MR1 is formed inside the NOx sensor element 10. The external exhaust gas GM is introduced into the first measurement chamber MR1 via a first diffusion resistor 116 which is disposed between the first pumping cell 111 and the oxygen concentration detection cell 112.

The first diffusion resistor 116 is composed of a porous body. The first diffusion resistor 116 is disposed in an introduction path 14, for the exhaust gas GM, which extends in the NOx sensor element 10 from an opening on the front side (left side in the drawing) to the first measurement chamber MR1. The first diffusion resistor 116 limits the amount of the exhaust gas GM introduced (passed) into the first measurement chamber MR1 per unit time.

A second diffusion resistor 117 which is composed of a porous body is disposed on the rear side (right side in the drawing) of the first measurement chamber MR1 in the inside of the NOx sensor element 10. The second measurement chamber MR2 into which a first chamber gas GM1 in the first measurement chamber MR1 is introduced via the second diffusion resistor 117 is formed on the rear side of the second diffusion resistor 117. The second measurement chamber MR2, together with the first measurement chamber MR1, corresponds to an example of the “measurement chamber” of the present invention. The second measurement chamber MR2 is formed so as to penetrate the insulation layers 114 and 115 and the oxygen concentration detection cell 112 in the stacking direction. The second-pump first electrode 145 of the second pumping cell 113 faces the second measurement chamber MR2.

A reference oxygen chamber RR is formed between the third solid electrolyte layer 151 of the oxygen concentration detection cell 112 and the second solid electrolyte layer 141 of the second pumping cell 113 in the inside of the NOx sensor element 10. The reference oxygen chamber RR is surrounded by the third solid electrolyte layer 151 of the oxygen concentration detection cell 112, the second solid electrolyte layer 141 of the second pumping cell 113, and the insulation layer 115. The reference electrode 157 of the oxygen concentration detection cell 112 and the second-pump second electrode 147 of the second pumping cell 113 are disposed so as to face the reference oxygen chamber RR.

The heater unit 180 is formed by stacking sheet-shaped insulation layers 171 and 173 made of an insulating ceramic such as alumina. The heater unit 180 includes a heater pattern 175 between the insulation layers 171 and 173, and generates heat by applying a current to the heater pattern 175.

### 1-3. Configuration of Gas Sensor Control Device 100

The gas sensor control device 100 mainly includes a microprocessor 60 and an electrical circuit unit 50. The electrical circuit unit 50 is electrically connected to the NOx sensor element 10 of the NOx sensor 20. The microprocessor 60 is configured, for example, as an information processing device having an arithmetic function and an information processing function. The microprocessor 60 includes a memory, etc. The microprocessor 60 is connected to an ECU 90. Accordingly, in the gas sensor control device 100, the microprocessor 60 drives and controls the NOx sensor element 10 in accordance with instructions from the ECU 90, and detects the concentration of NOx in the exhaust gas. The electrical circuit unit 50 includes a reference voltage comparison circuit 51, an Ip1 drive circuit 52, a Vs detection circuit 53, an Icp supply circuit 54, an Ip2 detection circuit 55, a Vp2 application circuit 56, and a heater drive circuit 57.

The Icp supply circuit 54 supplies a slight self-generation current Icp between the detection electrode 155 and the reference electrode 157 of the oxygen concentration detection cell 112. Accordingly, oxygen is pumped out from the inside of the first measurement chamber MR1 to the inside of the reference oxygen chamber RR, whereby the reference oxygen chamber RR can be set to a predetermined oxygen concentration atmosphere.

The Vs detection circuit 53 detects a concentration detection voltage Vs between the detection electrode 155 and the reference electrode 157 of the oxygen concentration detection cell 112, and outputs the detected concentration detection voltage Vs to the reference voltage comparison circuit 51.

The reference voltage comparison circuit 51 compares the concentration detection voltage Vs detected by the Vs detection circuit 53, with a predetermined target voltage Vr (e.g., 425 mV) outputted by the microprocessor 60, and outputs the comparison result to the Ip1 drive circuit 52.

The Ip1 drive circuit 52 supplies a first pump current Ip1 between the first-pump first electrode 135 and the first-pump second electrode 137 of the first pumping cell 111. The Ip1 drive circuit 52 controls the magnitude and the direction of the first pump current Ip1 on the basis of the comparison result by the reference voltage comparison circuit 51 such that the concentration detection voltage Vs is equal to the target voltage Vr. As a result, in the first pumping cell 111, oxygen is pumped out from the inside of the first measurement chamber MR1 to the outside of the NOx sensor element 10, or pumped in from the outside of the NOx sensor element 10 into the first measurement chamber MR1. Accordingly, the first pump current Ip1 flowing through the first pumping cell 111 is controlled such that the concentration detection voltage Vs between the detection electrode 155 and the reference electrode 157 of the oxygen concentration detection cell 112 is maintained at the predetermined target voltage Vr. Thus, the oxygen concentration of the first chamber gas GM1 in the first measurement chamber MR1 is controlled to a predetermined concentration. Then, the first chamber gas GM1 controlled to the predetermined oxygen concentration is introduced via the porous second diffusion resistor 117 into the second measurement chamber MR2.

The Vp2 application circuit 56 applies, between the second-pump first electrode 145 and the second-pump second electrode 147 of the second pumping cell 113, a second pump voltage Vp2 (e.g., 450 mV) capable of dissociating oxygen molecules and NOx (oxygen-containing gas) having a higher dissociation voltage than oxygen molecules in a second chamber gas GM2 in the second measurement chamber MR2. Accordingly, in the second measurement chamber MR2, oxygen and NOx in the second chamber gas GM2 in the second measurement chamber MR2 are dissociated by the catalytic action of the second-pump first electrode 145 of the second pumping cell 113. The oxygen ions obtained from the dissociation move through the second solid electrolyte layer 141, and a second pump current Ip2 (hereinafter, also referred to as pumping current) flows between the second-pump first electrode 145 and the second-pump second electrode 147. The Ip2 detection circuit 55 detects the magnitude of the second pump current Ip2 flowing between the second-pump first electrode 145 and the second-pump second electrode 147. The Ip2 detection circuit 55 detects the pumping current generated in the second pumping cell 113. The heater drive circuit 57 is controlled by the microprocessor 60 and performs energization control of the heater pattern 175 of the heater unit 180 to cause the heater unit 180 to generate heat. Accordingly, the first solid electrolyte layer 131 of the first pumping cell 111, the third solid electrolyte layer 151 of the oxygen concentration detection cell 112, and the second solid electrolyte layer 141 of the second pumping cell 113 are heated to an activation temperature (e.g., 750° C.).

With the above configuration, the NOx sensor element 10 is controlled by the gas sensor control device 100, and thus the concentration of the specific component (NOx) in the measurement target gas is detected from the magnitude of the second pump current Ip2.

### 1-4. Concentration Calculation Control of Gas Sensor Control Device 100

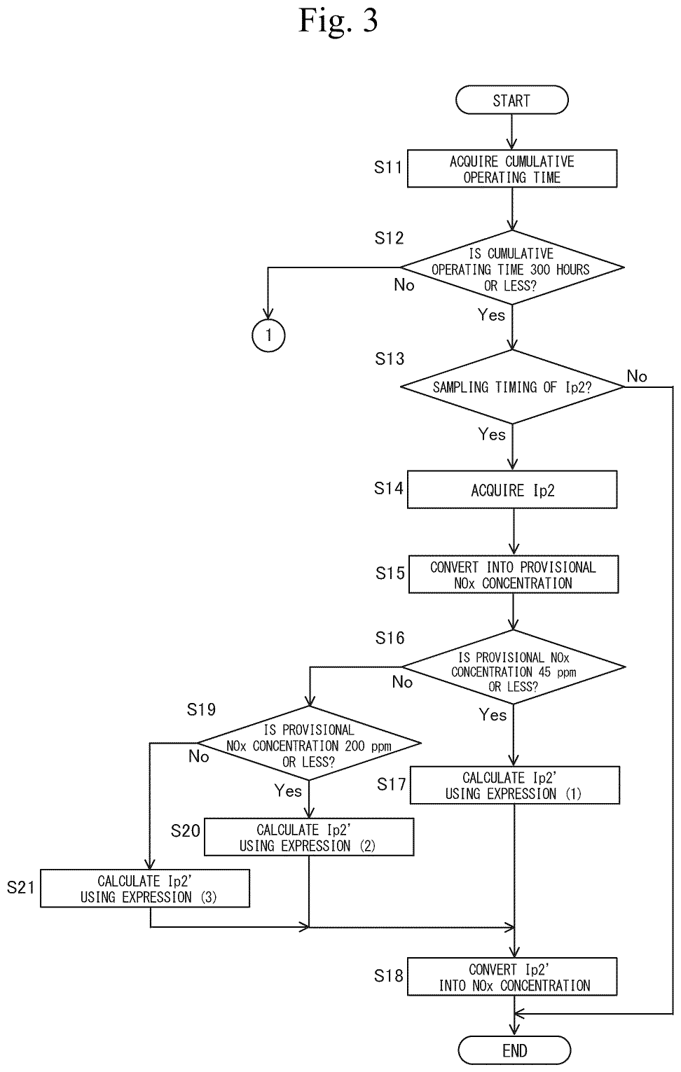

FIG. 3 to FIG. 7 show an example of concentration calculation control performed by the gas sensor control device 100. The gas sensor control device 100 (microprocessor 60) starts the concentration calculation control in FIG. 3 to FIG. 7 when a predetermined start condition is satisfied. The condition for starting the concentration calculation control in FIG. 3 to FIG. 7 may be, for example, that a start switch (ignition) of the vehicle on which the gas sensor system 1 is mounted is switched from an OFF state to an ON state, or may be other conditions. In a typical example described below, when the start switch of the vehicle is switched from the OFF state to the ON state, a start signal indicating that the start switch has been switched from the OFF state to the ON state is given from the ECU 90 to the microprocessor 60. When such a start signal is received, the microprocessor 60 starts the concentration calculation control in FIG. 3 to FIG. 7.

First, the microprocessor 60 acquires a cumulative operating time (step S11). The cumulative operating time is the total operating time of the gas sensor from a third reference time. For example, the microprocessor 60 has a built-in timer for clocking which is not shown, and measures the cumulative operating time.

In subsequent step S12, the microprocessor 60 determines whether or not the cumulative operating time is 300 hours or less. When the microprocessor 60 determines that the cumulative operating time is 300 hours or less (Yes in step S12), the microprocessor 60 determines whether or not the present time is a sampling time of the pumping current Ip2 (step S13). The pumping current Ip2 is a pumping current outputted from the second pumping cell 113. The microprocessor 60 is set so as to sample the pumping current Ip2, for example, every predetermined time (e.g., 10 ms). In this case, when a predetermined time (e.g., 10 ms) has elapsed from the last sampling, the microprocessor 60 determines that the present time is a sampling time. When the microprocessor 60 determines that the present time is not a sampling time (No in step S13), the microprocessor 60 ends the concentration calculation control. On the other hand, when the microprocessor 60 determines that the present time is a sampling time (Yes in step S13), the microprocessor 60 acquires the pumping current Ip2 (step S14).

In subsequent step S15, the microprocessor 60 converts the pumping current Ip2 into a provisional NOx concentration. The conversion from the pumping current Ip2 into the provisional NOx concentration may be performed, for example, by referring to a table (table stored in advance in the microprocessor 60) in which the pumping current Ip2 and the provisional NOx concentration are associated with each other, or through calculation using a predetermined arithmetic expression.

In subsequent step S16, the microprocessor 60 determines whether the provisional NOx concentration is 0 ppm or more and 45 ppm or less. When the microprocessor 60 determines that the provisional NOx concentration is 0 ppm or more and 45 ppm or less (Yes in step S16), the microprocessor 60 calculates a pumping current Ip2′ obtained by correcting the pumping current Ip (step S17). The microprocessor 60 calculates the pumping current Ip2′ using a correction expression in Math. 1 below (expression (1)). H is the cumulative operating time.

$$Ip {2}^{′} = Ip 2 - ( a {0}_{300} \times initial offset + b {0}_{300} ) \times \frac{H}{300} \qquad [ Math . 1 ]$$

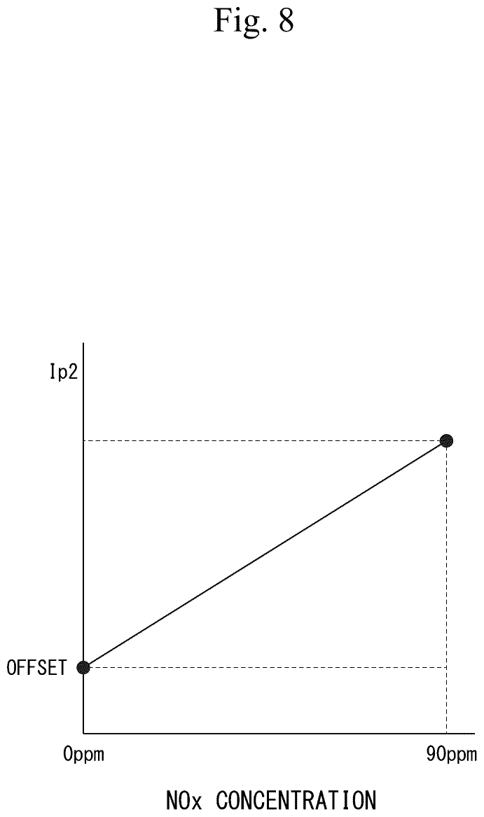

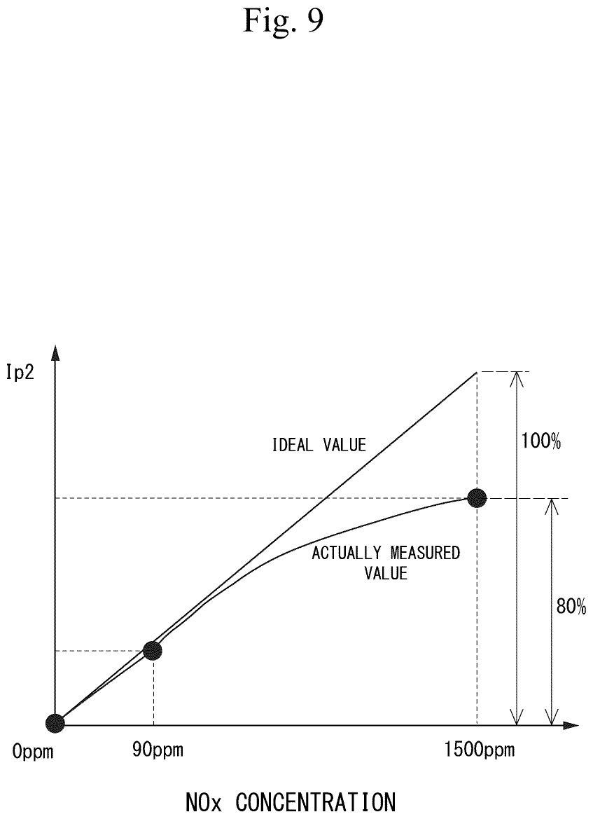

Here, the numerical values used for calculating the pumping current Ip2′ (numerical values used in the expressions in Math. 1 to Math. 15) will be described. As the numerical values used for calculating the pumping current Ip2′ (numerical values used in the expressions in Math. 1 to Math. 15), an initial offset and an initial Ip2 decrease ratio of the NOx sensor element 10 are stored in the microprocessor 60. The offset is a current value Ip2 when the concentration of the specific component (NOx) at a predetermined reference time (first reference time) is 0 as shown in FIG. 8. The initial offset is an offset at the first reference time (e.g., the time at which the cumulative operating time is 0 hours). FIG. 8 is an explanatory diagram schematically showing an example of a relationship between a NOx concentration and Ip2 outputted from the NOx sensor element 10. The Ip2 decrease ratio is a value based on the difference between an ideal value and the current value Ip2 when the concentration of the specific component (NOx) in the measurement target gas is a predetermined set concentration. For example, the Ip2 decrease ratio is the ratio of a decrease in an actually measured Ip2 value with respect to an ideal Ip2 value at a predetermined NOx concentration (e.g., 1500 ppm) as shown in FIG. 9. For example, when an Ip2 value actually measured when the NOx concentration is 1500 ppm is 80% of the ideal Ip2 value, the Ip2 decrease ratio is-20%. The initial Ip2 decrease ratio is an Ip2 decrease ratio at a second reference time (e.g., the time at which the cumulative operating time is 0 hours).

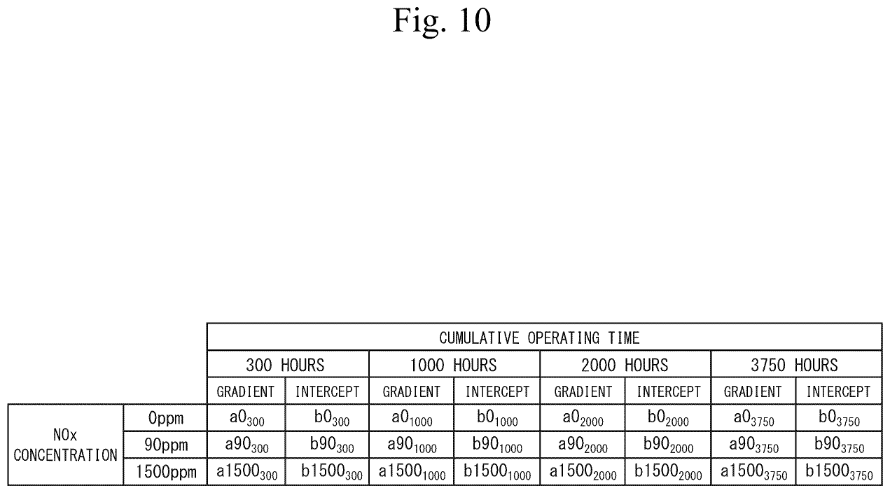

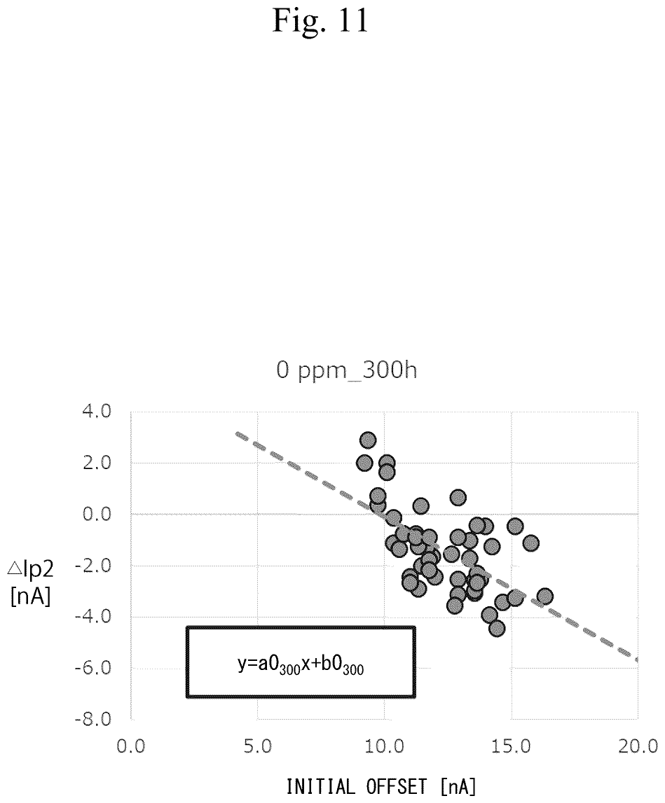

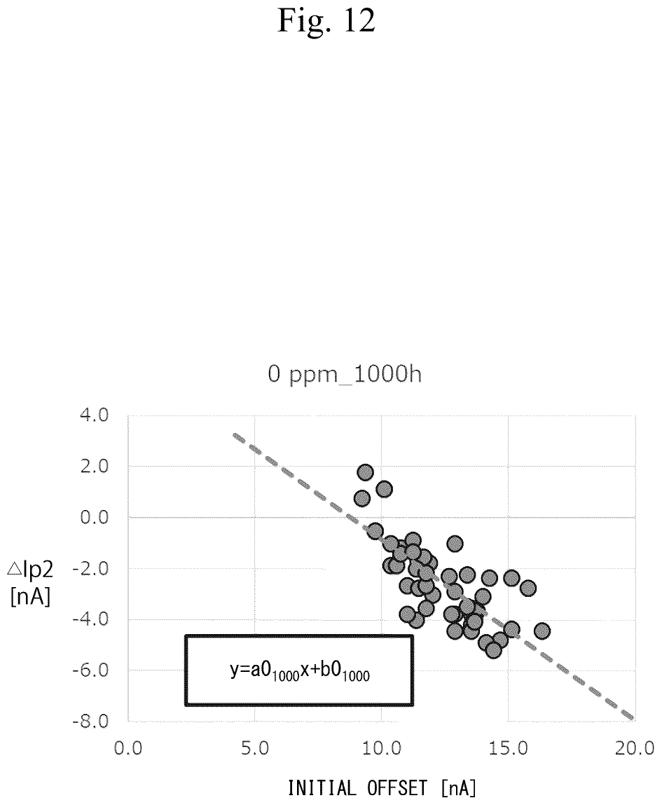

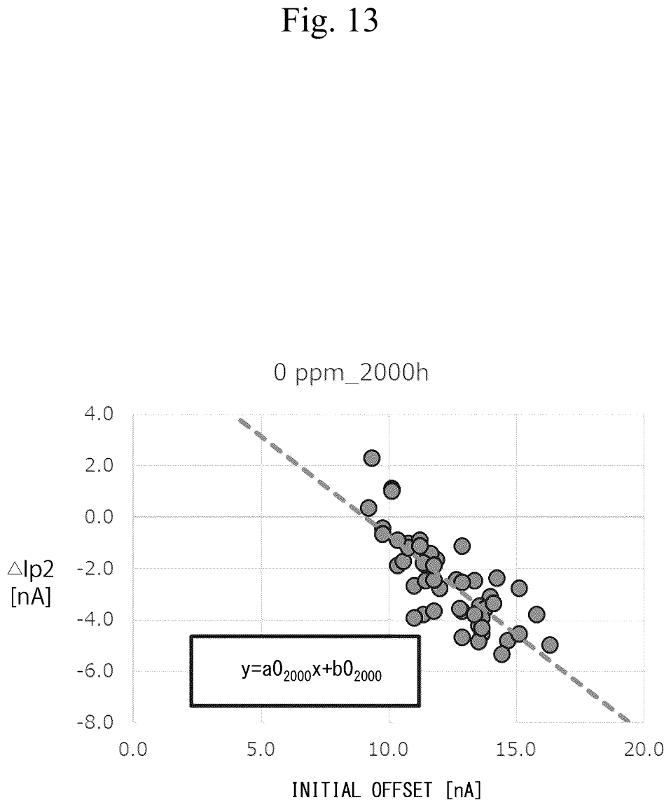

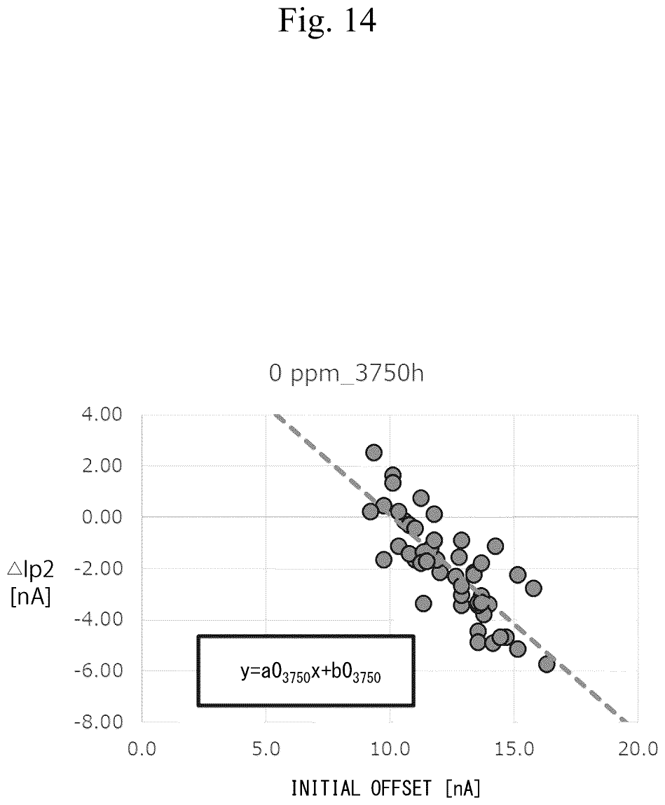

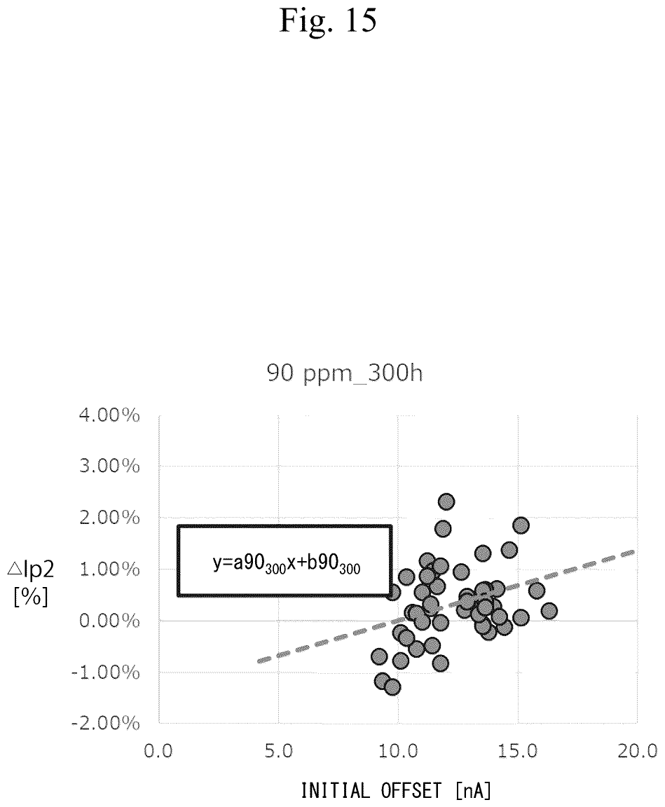

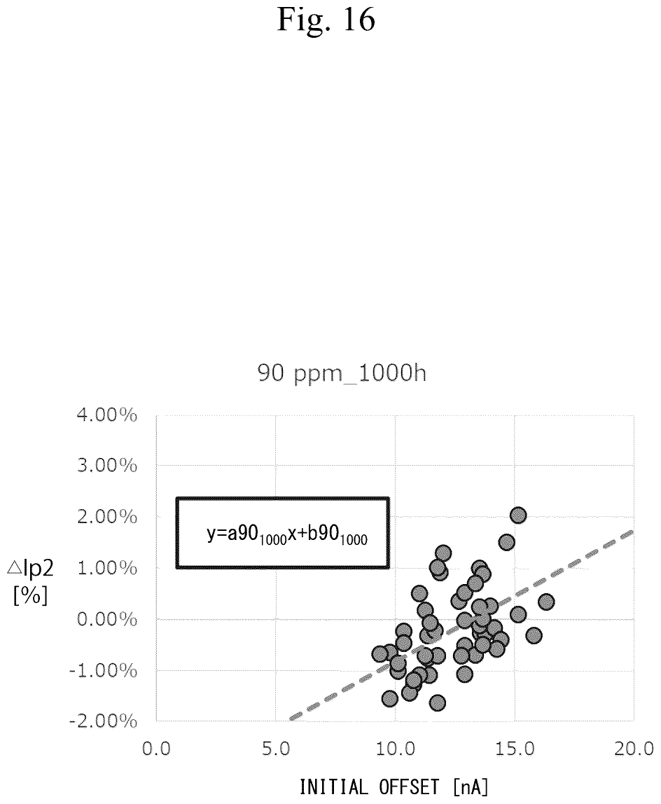

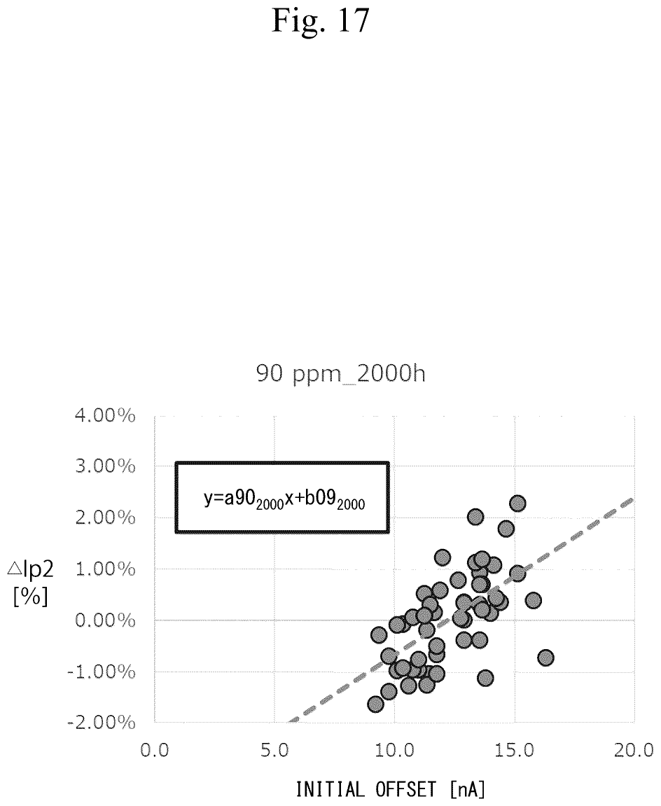

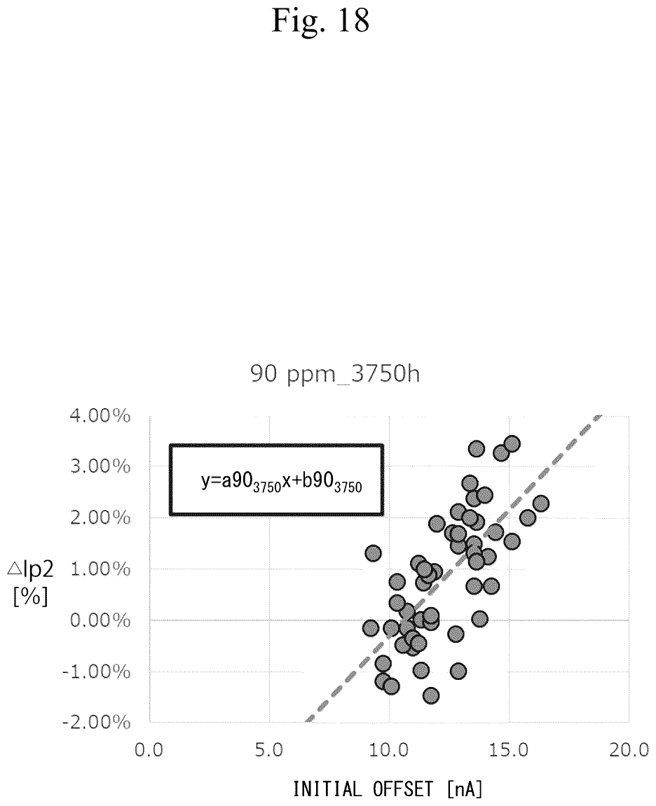

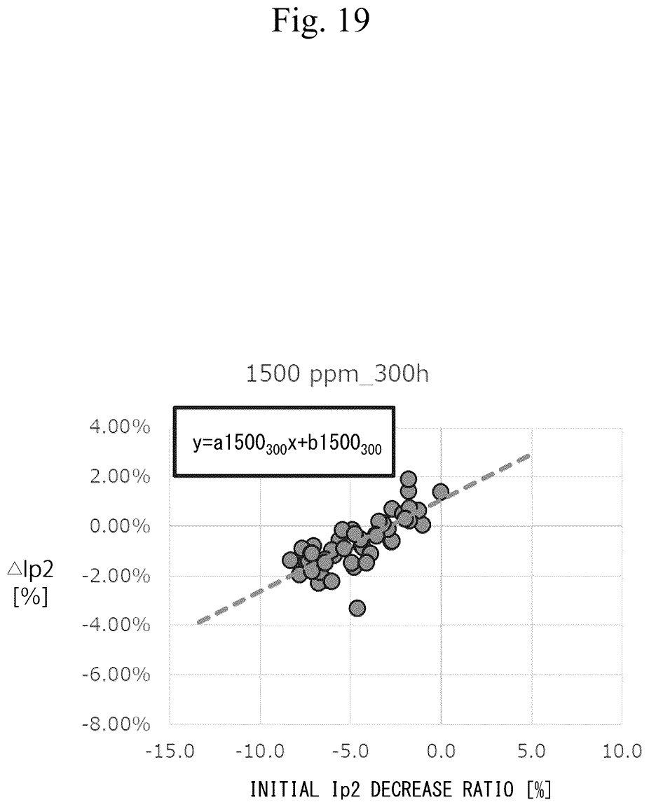

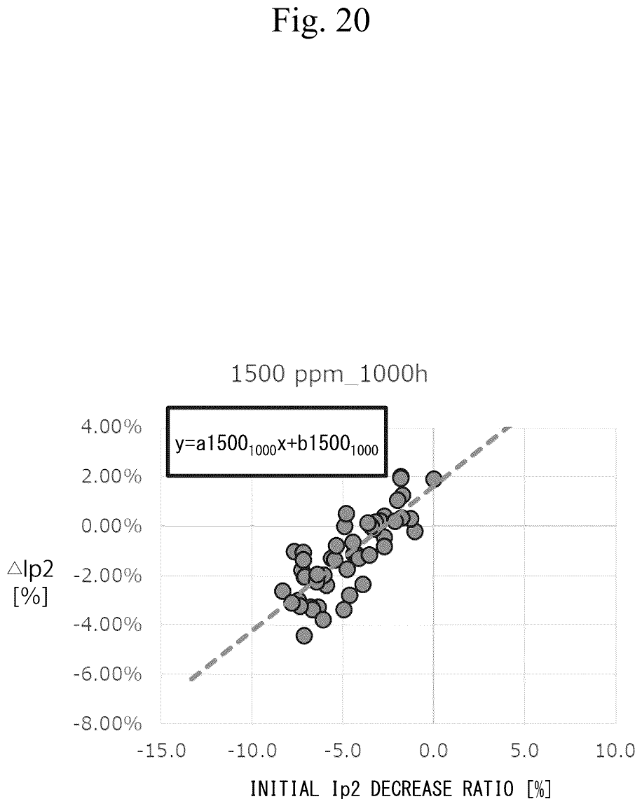

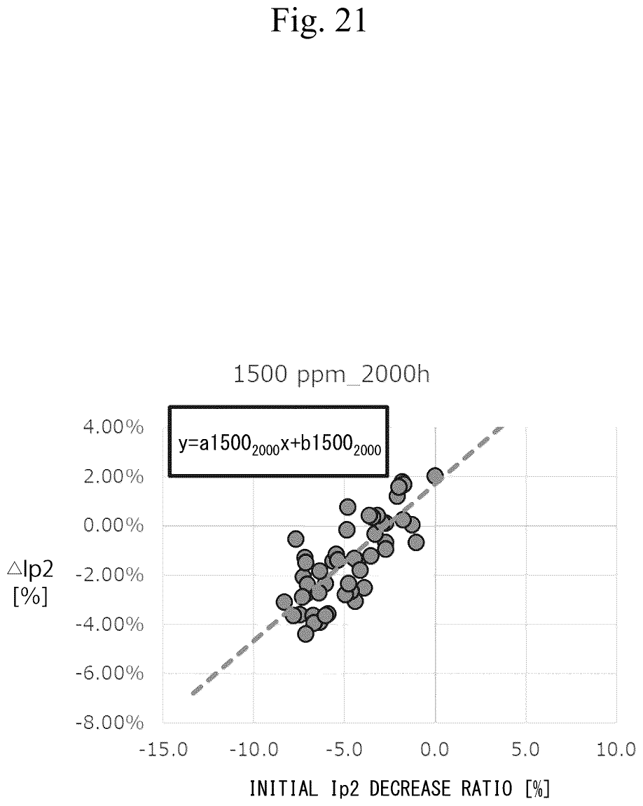

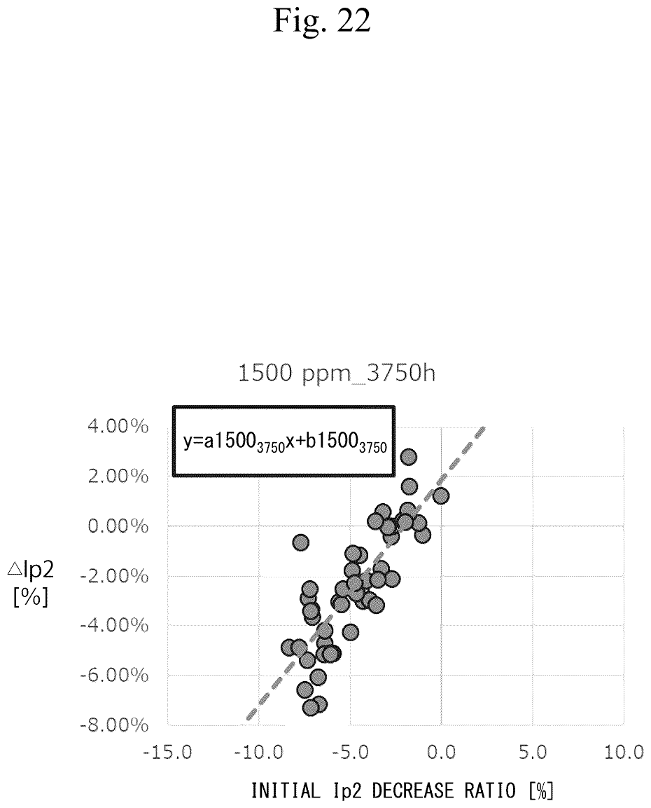

Also, the correction expressions used for calculating the pumping current Ip2′ (expressions in Math. 1 to Math. 15) are stored in the microprocessor 60. Specifically, as the numerical values used in the correction expressions (expressions in Math. 1 to Math. 15), gradients a and intercepts b are stored as shown in FIG. 10. The microprocessor 60 corresponds to an example of the “storage unit” of the present invention. A gradient a is a gradient (change rate) of a graph of a linear function of ΔIp2 with an initial offset or an initial Ip2 decrease ratio as a variable. ΔIp2 is an amount of change or a rate of change of Ip2 when the cumulative operating time is a predetermined time (time greater than 0 hours) with respect to Ip2 when the cumulative operating time is 0 hours. An intercept b is an intercept of the graph of the linear function of ΔIp2 with an initial offset or an initial Ip2 decrease ratio as a variable (value when the variable is 0). The linear function of ΔIp2 with an initial offset or an initial Ip2 decrease ratio as a variable is obtained, for example, by linear approximation of values of ΔIp2 corresponding to initial offsets or initial Ip2 decrease ratios acquired from a plurality of NOx sensor elements 10 different from the NOx sensor element 10 used for the concentration calculation control. For example, a graph shown in FIG. 11 shows a linear function of ΔIp2 with an initial offset as a variable when the NOx concentration is 0 ppm and the cumulative operating time is 300 hours. Based on this, a gradient a0₃₀₀ and an intercept b0₃₀₀ are obtained, and are stored as values in the microprocessor 60 as shown in FIG. 10. Similarly, based on relationships shown in FIG. 12 to FIG. 22, each gradient a and each intercept b are obtained, and are stored in the microprocessor 60. In FIG. 10, for example, “0” in “a0₃₀₀” indicates a NOx concentration, and the subscript number “₃₀₀” indicates a cumulative operating time. In the case where the NOx concentration is 0 ppm and 90 ppm (data in FIG. 11 to FIG. 18), an initial offset is set as a variable, and in the case where the NOx concentration is 1500 ppm (data in FIG. 19 to FIG. 22), an initial Ip2 decrease ratio is set as a variable.

As described above, the microprocessor 60 divides the cumulative operating time into a plurality of predetermined time segments, and also divides the NOx concentration corresponding to the current value into predetermined concentration segments, and stores a plurality of patterns of a linear expression with an initial offset or a difference as a variable, in association with at least either the predetermined time segments or the predetermined concentration segments. For example, for cumulative operating times that are 0 hours or more and 650 hours or less, a0₃₀₀, b0₃₀₀, a90₃₀₀, b90₃₀₀, a1500₃₀₀, and b1500₃₀₀ are stored. For cumulative operating times that are greater than 650 hours and 1500 hours or less, a0₁₀₀₀, b0₁₀₀₀, a90₁₀₀₀, b90₁₀₀₀, a1500₁₀₀₀, and b1500₁₀₀₀ are stored. For cumulative operating times that are greater than 1500 hours and 2875 hours or less, a0₁₅₀₀, b0₁₅₀₀, a90₁₅₀₀, b90₁₅₀₀, a1500₁₅₀₀, and b1500₁₅₀₀ are stored. For cumulative operating times that are greater than 2875 hours, a0₃₇₅₀, b0₃₇₅₀, a90₃₇₅₀, b90₃₇₅₀, a1500₃₇₅₀, and b1500₃₇₅₀ are stored. In this way, a coefficient of the linear expression with an initial offset or an initial Ip2 decrease ratio can be selected in accordance with at least either the cumulative operating time or the NOx concentration corresponding to the current value. Thus, the concentration of NOx in the measurement target gas can be calculated using an appropriate linear expression corresponding to at least either the cumulative operating time or the NOx concentration corresponding to the current value.

The microprocessor 60 corresponds to an example of the “calculation unit” of the present invention. The microprocessor 60 calculates the concentration of the specific component (NOx) from the pumping current Ip2. When calculating the concentration of NOx, the microprocessor 60 uses a correction expression (expression (1)) based on an index in which the deterioration state of the NOx sensor is reflected (index including at least either the initial offset or the initial Ip2 decrease ratio) and the cumulative operating time. Therefore, the microprocessor 60 can calculate the concentration of NOx in the measurement target gas such that the deterioration state of the NOx sensor 20 is reflected therein.

The microprocessor 60 calculates the concentration of NOx in the measurement target gas on the basis of the cumulative operating time in addition to the pumping current Ip2 and the index. Specifically, in the expression in Math. 1, (a0₃₀₀×initial offset+b0₃₀₀) is multiplied by H/300. Accordingly, the concentration of NOx in which the cumulative elapsed time is reflected can be calculated.

When the magnitude of the pumping current is in a predetermined low-current state, the microprocessor 60 uses the initial offset in the calculation expressions of Ip2′ (expression in Math. 1 and expression in Math. 2 described later). The predetermined low-current state is a state where the current value is smaller than a predetermined threshold value. The predetermined low-current state is, for example, the current state of the pumping current outputted when the provisional NOx concentration is 0 ppm or more and 200 ppm or less (state where the pumping current has a relatively low current value). In the predetermined low-current state, ΔIp2 tends to be more correlated with the initial offset than with the initial Ip2 decrease ratio, so that Ip2′ can be calculated using highly accurate gradient a and intercept b.

The NOx sensor 20 detects the concentration of NOx in the measurement target gas on at least one of the upstream side and the downstream side with respect to the exhaust gas purifying device 3 in the exhaust pipe 7. When the concentration of NOx is detected as a relatively low concentration on the downstream side with respect to the exhaust gas purifying device 3 in the exhaust pipe 7, the concentration of NOx in the measurement target gas can be calculated such that the initial offset is reflected therein. When the concentration of NOx is detected as a relatively high concentration on the upstream with respect to the exhaust gas purifying device 3 in the exhaust pipe 7, the concentration of NOx in the measurement target gas can be calculated such that the initial Ip2 decrease ratio is reflected therein.

In subsequent step S18, the microprocessor 60 converts the pumping current Ip2′ into a NOx concentration (hereinafter, referred to as corrected NOx concentration). The conversion from the pumping current Ip2′ into the corrected NOx concentration may be performed by referring to the table used for the conversion from the pumping current Ip2 into the provisional NOx concentration (step S15) (table in which the pumping current Ip2 and the NOx concentration are associated with each other), or may be performed through calculation using a predetermined arithmetic expression. After step S18, the concentration calculation control is ended.

When, in step S16, the microprocessor 60 determines that the provisional NOx concentration is not 0 ppm or more and 45 ppm or less (greater than 45 ppm) (No in step S16), the microprocessor 60 determines whether the provisional NOx concentration is greater than 45 ppm and 200 ppm or less (step S19). When the microprocessor 60 determines that the provisional NOx concentration is greater than 45 ppm and 200 ppm or less (Yes in step S19), the microprocessor 60 calculates the pumping current Ip2′ using the correction expression in Math. 2 below (expression (2)) (step S20).

$$Ip {2}^{′} = Ip 2 \times \frac{1}{1 + ( a {90}_{300} \times initial offset + b {90}_{300} ) \times \frac{H}{300}} \qquad [ Math . 2 ]$$

On the other hand, when the microprocessor 60 determines that the provisional NOx concentration is not greater than 45 ppm and 200 ppm or less (greater than 200 ppm) (No in step S19), the microprocessor 60 calculates the pumping current Ip2′ using the correction expression in Math. 3 below (expression (3)) (step S21).

$$Ip {2}^{′} = Ip 2 \times \frac{1}{1 + ( a {1500}_{300} \times Ip 2 decrease ratio + b {1500}_{300} ) \times \frac{H}{300}} \qquad [ Math . 3 ]$$

After step S20 or S21, the microprocessor 60 converts the pumping current Ip2′ into a NOx concentration (hereinafter, referred to as corrected NOx concentration) (step S18). After step S18, the concentration calculation control is ended.

When the magnitude of the pumping current is in a predetermined high-current state, the microprocessor 60 uses the initial Ip2 decrease ratio in the calculation expression of Ip2′ (expression in Math. 3). The predetermined high-current state is a state where the current value is greater than a predetermined threshold value. The predetermined high-current state is, for example, the current state of the pumping current outputted when the provisional NOx concentration is greater than 200 ppm (state where the pumping current has a relatively high current value). In the predetermined high-current state, the initial Ip2 decrease ratio and ΔIp2 tends to be correlated with each other, so that Ip2′ can be calculated using highly accurate gradient a and intercept b.

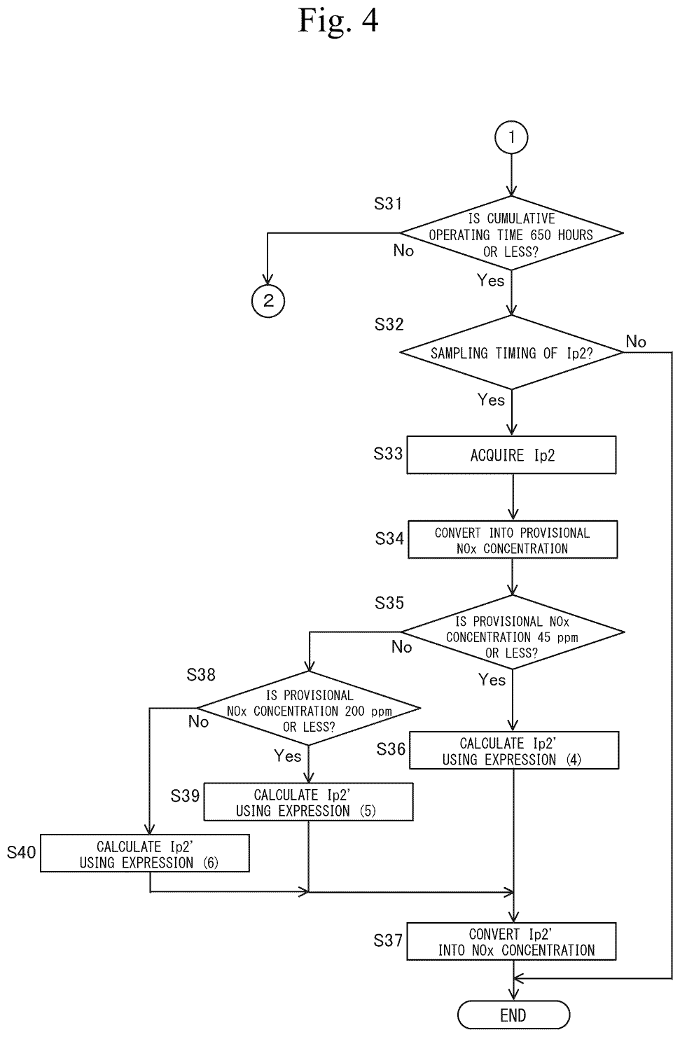

When, in step S12, the microprocessor 60 determines that the cumulative operating time is not 300 hours or less (greater than 300 hours) (No in step S12), the microprocessor 60 determines in step S31 shown in FIG. 4 whether or not the cumulative operating time is 650 hours or less. When the microprocessor 60 determines that the cumulative operating time is 650 hours or less (Yes in step S31), the microprocessor 60 performs steps S32 to S35 which are the same as steps S13 to S16. When, in step S35, the microprocessor 60 determines that the provisional NOx concentration is 0 ppm or more and 45 ppm or less (Yes in step S35), the microprocessor 60 calculates the pumping current Ip2′ obtained by correcting the pumping current Ip (step S36). The microprocessor 60 calculates the pumping current Ip2′ using the correction expression in Math. 4 below (expression (4)).

$$Ip {2}^{′} = Ip 2 - ( a {0}_{300} \times initial offset + b {0}_{300} ) \qquad [ Math . 4 ]$$

In subsequent step S37, similar to step S18, the microprocessor 60 converts the pumping current Ip2′ into a NOx concentration (hereinafter, referred to as corrected NOx concentration). After step S37, the concentration calculation control is ended.

When, in step S35, the microprocessor 60 determines that the provisional NOx concentration is not 0 ppm or more and 45 ppm or less (greater than 45 ppm) (No in step S35), the microprocessor 60 determines whether the provisional NOx concentration is greater than 45 ppm and 200 ppm or less (step S38). When the microprocessor 60 determines that the provisional NOx concentration is greater than 45 ppm and 200 ppm or less (Yes in step S38), the microprocessor 60 calculates the pumping current Ip2′ using the correction expression in Math. 5 below (expression (5)) (step S39).

$$Ip {2}^{′} = Ip 2 \times \frac{1}{1 + ( a {90}_{300} \times initial offset + b {90}_{300} )} \qquad [ Math . 5 ]$$

On the other hand, when the microprocessor 60 determines that the provisional NOx concentration is not greater than 45 ppm and 200 ppm or less (greater than 200 ppm) (No in step S38), the microprocessor 60 calculates the pumping current Ip2′ using the correction expression in Math. 6 below (expression (6)) (step S40).

$$Ip {2}^{′} = Ip 2 \times \frac{1}{1 + ( a {1500}_{300} \times Ip 2 decrease ratio + b {1500}_{300} )} \qquad [ Math . 6 ]$$

After step S39 or S40, the microprocessor 60 converts the pumping current Ip2′ into a NOx concentration (hereinafter, referred to as corrected NOx concentration) (step S37). After step S37, the concentration calculation control is ended.

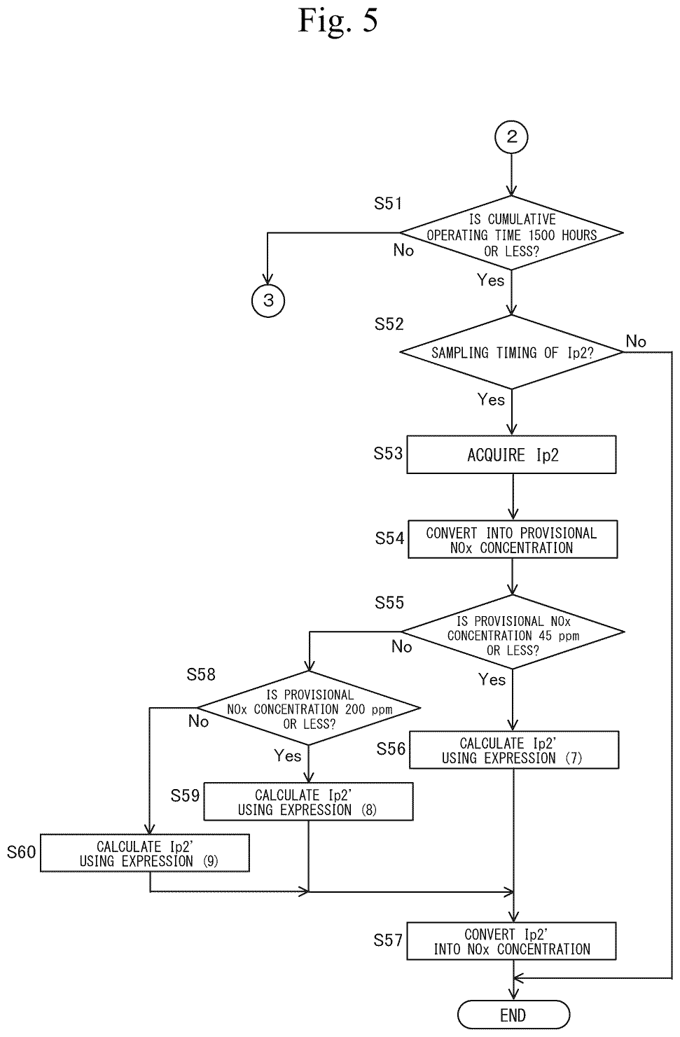

When, in step S31, the microprocessor 60 determines that the cumulative operating time is not 650 hours or less (greater than 650 hours) (No in step S31), the microprocessor 60 determines in step S51 shown in FIG. 5 whether or not the cumulative operating time is 1500 hours or less. When the microprocessor 60 determines that the cumulative operating time is 1500 hours or less (Yes in step S51), the microprocessor 60 performs steps S52 to S55 which are the same as steps S13 to S16. When, in step S55, the microprocessor 60 determines that the provisional NOx concentration is 0 ppm or more and 45 ppm or less (Yes in step S55), the microprocessor 60 calculates the pumping current Ip2′ obtained by correcting the pumping current Ip (step S56). The microprocessor 60 calculates the pumping current Ip2′ using the correction expression in Math. 7 below (expression (7)).

$$Ip {2}^{′} = Ip 2 - ( a {0}_{1000} \times initial offset + b {0}_{1000} ) \qquad [ Math . 7 ]$$

In subsequent step S57, similar to step S18, the microprocessor 60 converts the pumping current Ip2′ into a NOx concentration (hereinafter, referred to as corrected NOx concentration). After step S57, the concentration calculation control is ended.

When, in step S55, the microprocessor 60 determines that the provisional NOx concentration is not 0 ppm or more and 45 ppm or less (greater than 45 ppm) (No in step S55), the microprocessor 60 determines whether the provisional NOx concentration is greater than 45 ppm and 200 ppm or less (step S58). When the microprocessor 60 determines that the provisional NOx concentration is greater than 45 ppm and 200 ppm or less (Yes in step S58), the microprocessor 60 calculates the pumping current Ip2′ using the correction expression in Math. 8 below (expression (8)) (step S59).

$$Ip {2}^{′} = Ip 2 \times \frac{1}{1 + ( a {90}_{1000} \times initial offset + b {90}_{1000} )} \qquad [ Math . 8 ]$$

On the other hand, when the microprocessor 60 determines that the provisional NOx concentration is not greater than 45 ppm and 200 ppm or less (greater than 200 ppm) (No in step S58), the microprocessor 60 calculates the pumping current Ip2′ using the correction expression in Math. 9 below (expression (9)) (step S60).

$$Ip {2}^{′} = Ip 2 \times \frac{1}{1 + ( a {1500}_{1000} \times Ip 2 decrease ratio + b {1500}_{1000} )} \qquad [ Math . 9 ]$$

After step S59 or S60, the microprocessor 60 converts the pumping current Ip2′ into a NOx concentration (hereinafter, referred to as corrected NOx concentration) (step S57). After step S57, the concentration calculation control is ended.

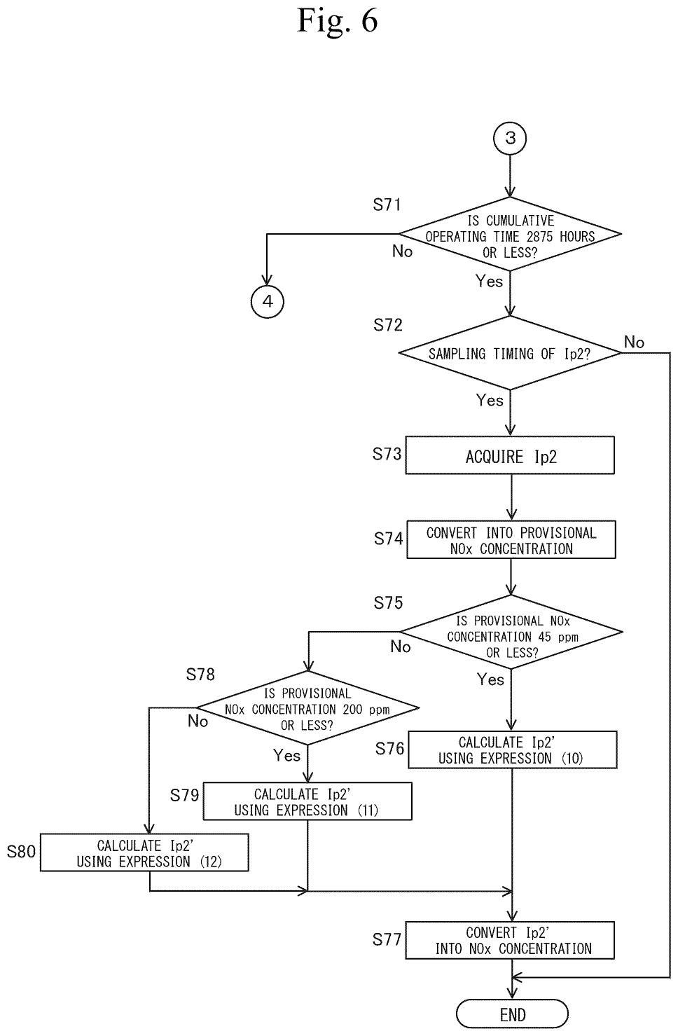

When, in step S51, the microprocessor 60 determines that the cumulative operating time is not 1500 hours or less (greater than 1500 hours) (No in step S51), the microprocessor 60 determines in step S71 shown in FIG. 6 whether or not the cumulative operating time is 2785 hours or less. When the microprocessor 60 determines that the cumulative operating time is 2785 hours or less (Yes in step S71), the microprocessor 60 performs steps S72 to S75 which are the same as steps S13 to S16. When, in step S75, the microprocessor 60 determines that the provisional NOx concentration is 0 ppm or more and 45 ppm or less (Yes in step S75), the microprocessor 60 calculates the pumping current Ip2′ obtained by correcting the pumping current Ip (step S76). The microprocessor 60 calculates the pumping current Ip2′ using the correction expression in Math. 10 below (expression (10)).

$$Ip {2}^{′} = Ip 2 - ( a {0}_{2000} \times initial offset + b {0}_{2000} ) \qquad [ Math . 10 ]$$

In subsequent step S77, similar to step S18, the microprocessor 60 converts the pumping current Ip2′ into a NOx concentration (hereinafter, referred to as corrected NOx concentration). After step S77, the concentration calculation control is ended.

When, in step S75, the microprocessor 60 determines that the provisional NOx concentration is not 0 ppm or more and 45 ppm or less (greater than 45 ppm) (No in step S75), the microprocessor 60 determines whether the provisional NOx concentration is greater than 45 ppm and 200 ppm or less (step S78). When the microprocessor 60 determines that the provisional NOx concentration is greater than 45 ppm and 200 ppm or less (Yes in step S78), the microprocessor 60 calculates the pumping current Ip2′ using the correction expression in Math. 11 below (expression (11)) (step S79).

$$Ip {2}^{′} = Ip 2 \times \frac{1}{1 + ( a {90}_{2000} \times initial offset + b {90}_{2000} )} \qquad [ Math . 11 ]$$

On the other hand, when the microprocessor 60 determines that the provisional NOx concentration is not greater than 45 ppm and 200 ppm or less (greater than 200 ppm) (No in step S78), the microprocessor 60 calculates the pumping current Ip2′ using the correction expression in Math. 12 below (expression (12)) (step S80).

$$Ip {2}^{′} = Ip 2 \times \frac{1}{1 + ( a {1500}_{2000} \times Ip 2 decrease ratio + b {1500}_{2000} )} \qquad [ Math . 12 ]$$

After step S79 or S80, the microprocessor 60 converts the pumping current Ip2′ into a NOx concentration (hereinafter, referred to as corrected NOx concentration) (step S77). After step S77, the concentration calculation control is ended.

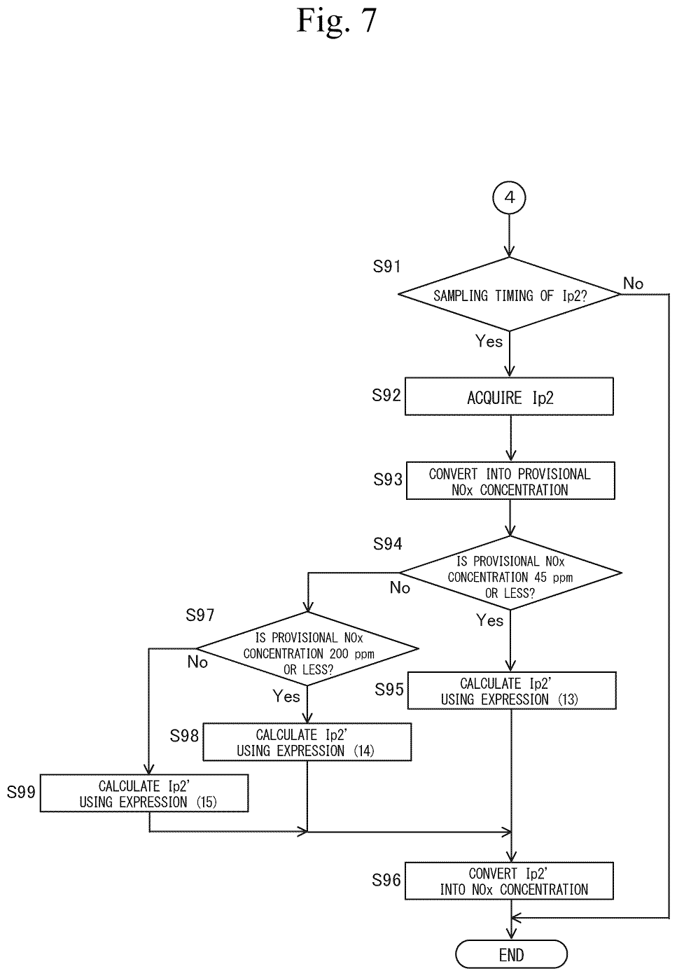

When, in step S71, the microprocessor 60 determines that the cumulative operating time is not 2785 hours or less (greater than 2785 hours) (No in step S71), the microprocessor 60 performs steps S91 to S94 shown in FIG. 7, similar to steps S13 to S16. When, in step S94, the microprocessor 60 determines that the provisional NOx concentration is 0 ppm or more and 45 ppm or less (Yes in step S94), the microprocessor 60 calculates the pumping current Ip2′ obtained by correcting the pumping current Ip (step S95). The microprocessor 60 calculates the pumping current Ip2′ using the correction expression in Math. 13 below (expression (13)).

$$Ip {2}^{′} = Ip 2 - ( a {0}_{3750} \times initial offset + b {0}_{3750} ) \qquad [ Math . 13 ]$$

In subsequent step S96, similar to step S18, the microprocessor 60 converts the pumping current Ip2′ into a NOx concentration (hereinafter, referred to as corrected NOx concentration). After step S96, the concentration calculation control is ended.

When, in step S94, the microprocessor 60 determines that the provisional NOx concentration is not 0 ppm or more and 45 ppm or less (greater than 45 ppm) (No in step S94), the microprocessor 60 determines whether the provisional NOx concentration is greater than 45 ppm and 200 ppm or less (step S97). When the microprocessor 60 determines that the provisional NOx concentration is greater than 45 ppm and 200 ppm or less (Yes in step S97), the microprocessor 60 calculates the pumping current Ip2′ using the correction expression in Math. 14 below (expression (14)) (step S98).

$$Ip {2}^{′} = Ip 2 \times \frac{1}{1 + ( a {90}_{3750} \times initial offset + b {90}_{3750} )} \qquad [ Math . 14 ]$$

On the other hand, when the microprocessor 60 determines that the provisional NOx concentration is not greater than 45 ppm and 200 ppm or less (greater than 200 ppm) (No in step S97), the microprocessor 60 calculates the pumping current Ip2′ using the correction expression in Math. 15 below (expression (15)) (step S99).

$$Ip {2}^{′} = Ip 2 \times \frac{1}{1 + ( a {1500}_{3750} \times Ip 2 decrease ratio + b {1500}_{3750} )} \qquad [ Math . 15 ]$$

After step S98 or S99, the microprocessor 60 converts the pumping current Ip2′ into a NOx concentration (hereinafter, referred to as corrected NOx concentration) (step S96). After step S96, the concentration calculation control is ended.

### 1-5. Advantageous Effects of First Embodiment

In the first embodiment, the concentration of NOx in the measurement target gas can be calculated such that the index in which the deterioration state of the NOx sensor 20 is reflected (index including at least either the initial offset or the initial Ip2 decrease ratio) and the cumulative operating time are reflected to the pumping current Ip2. Therefore, the concentration of NOx in the measurement target gas can be calculated such that the deterioration state of the NOx sensor 20 is reflected therein.

Furthermore, in the first embodiment, when the concentration of NOx in the measurement target gas is relatively high (in the case of the predetermined high-current state), the concentration of NOx in the measurement target gas can be calculated such that the initial Ip2 decrease ratio is reflected therein. On the other hand, when the concentration of NOx in the measurement target gas is relatively low (in the case of the predetermined low-current state), the concentration of NOx in the measurement target gas can be calculated such that the initial offset is reflected therein.

Furthermore, in the first embodiment, since a linear expression with an initial offset or a difference as a variable can be selected in accordance with the cumulative operating time and the current value, the concentration of the specific component in the measurement target gas can be corrected using an appropriate linear expression corresponding to the cumulative operating time and the current value.

Furthermore, in the first embodiment, when the concentration of NOx is detected as a relatively high concentration on the upstream side with respect to the exhaust gas purifying device 3, the concentration of NOx in the measurement target gas can be calculated such that the initial Ip2 decrease ratio is reflected therein. On the other hand, when the concentration of NOx is detected as a relatively low concentration on the downstream side with respect to the exhaust gas purifying device 3, the concentration of NOx in the measurement target gas can be calculated such that the initial offset is reflected therein.

### 2. Second Embodiment

A gas sensor system of a second embodiment is mainly different from the first embodiment in that quadratic functions are used for the gradient a and the intercept b which are used for calculating Ip2′, and other points are in common with the first embodiment. The same components as those of the first embodiment are designated by the same reference numerals, and the detailed description thereof is omitted.

### 2-1. Concentration Calculation Control of Gas Sensor Control Device 100

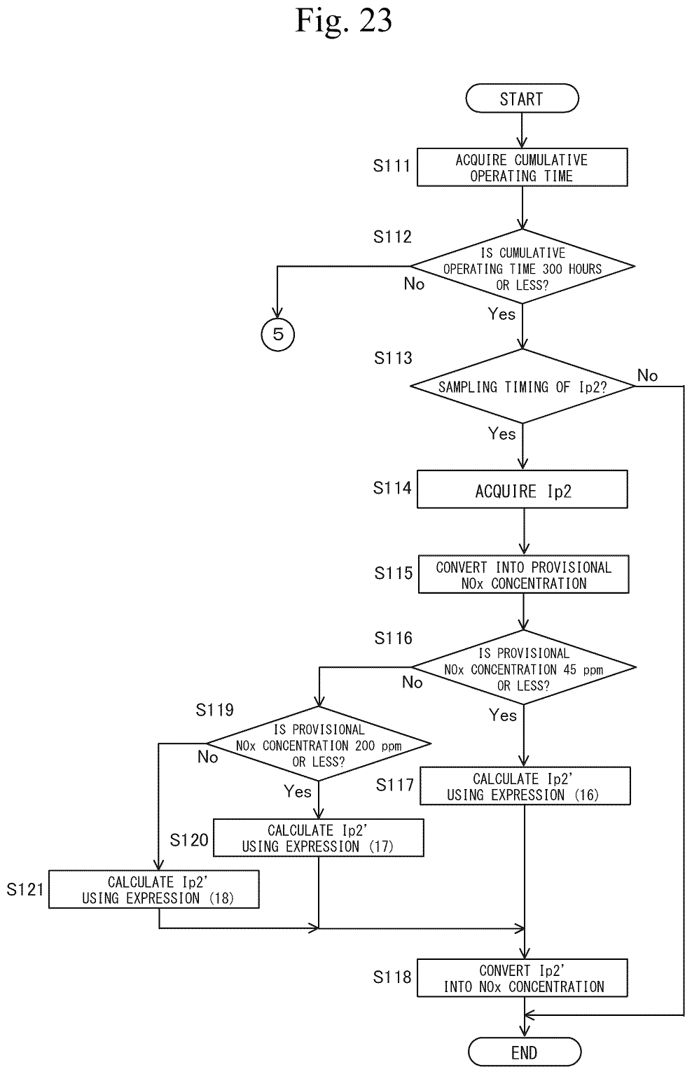

FIG. 23 to FIG. 25 show an example of the concentration calculation control performed by the gas sensor control device 100 of the second embodiment. Similar to the concentration calculation control of the first embodiment, the concentration calculation control in FIG. 23 to FIG. 25 is started when a predetermined start condition is satisfied.

The microprocessor 60 performs S111 to S121 shown in FIG. 23, as the same control as in steps S11 to S21 of the first embodiment. In step S117, the microprocessor 60 calculates the pumping current Ip2′ using a correction expression in Math. 16 below (expression (16)).

$$Ip {2}^{′} = Ip 2 - ( α {0}_{300} \times initial offset + b {0}_{300} ) \times \frac{H}{300} \qquad [ Math . 16 ]$$

The expression in Math. 16 is the same as the expression in Math. 1 of the first embodiment, and the detailed description thereof is omitted. As in the first embodiment, the correction expressions used for calculating the pumping current Ip2′ (expressions in Math. 16 to Math. 24) are stored. Specifically, as the numerical values used in the correction expressions (expressions in Math. 16 to Math. 24), the initial offset and the initial Ip2 decrease ratio of the NOx sensor element 10 are stored. In addition, as in the first embodiment, gradients a and intercepts b are stored in the microprocessor 60 as shown in FIG. 10.

As in the first embodiment, the microprocessor 60 calculates the concentration of NOx in the measurement target gas on the basis of an index including at least either the initial offset or the initial Ip2 decrease ratio and the cumulative operating time. Accordingly, the concentration of NOx in the measurement target gas can be calculated such that the index in which the deterioration state of the NOx sensor is reflected (index including at least either the initial offset or the initial Ip2 decrease ratio) is reflected to the pumping current Ip2. Therefore, the concentration of NOx in the measurement target gas can be calculated such that the deterioration state of the NOx sensor 20 is reflected therein.

In step S120, the microprocessor 60 calculates the pumping current Ip2′ using the correction expression in Math. 17 below (expression (17)). The expression in Math. 17 is the same as the expression in Math. 2 of the first embodiment, and the detailed description thereof is omitted.

$$Ip {2}^{′} = Ip 2 - \frac{1}{( α {90}_{300} \times initial offset + b {0}_{300} ) \times \frac{H}{300}} \qquad [ Math . 17 ]$$

In step S121, the pumping current Ip2′ is calculated using the correction expression in Math. 18 below (expression (18)). The expression in Math. 18 is the same as the expression in Math. 3 of the first embodiment, and the detailed description thereof is omitted.

$$Ip {2}^{′} = Ip 2 - \frac{1}{( α {1500}_{300} \times Ip 2 decrease ratio + b {150 \; 0}_{300} ) \times \frac{H}{300}} \qquad [ Math . 18 ]$$

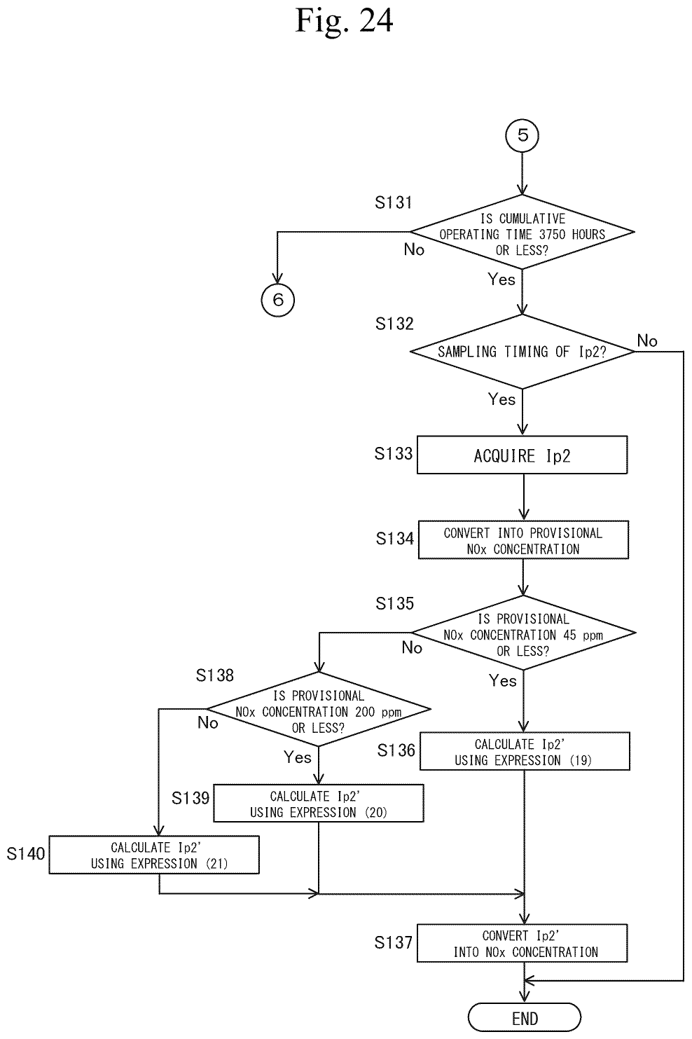

When, in step S112, the microprocessor 60 determines that the cumulative operating time is not 300 hours or less (greater than 300 hours) (No in step S112), the microprocessor 60 determines in step S131 shown in FIG. 24 whether or not the cumulative operating time is 3750 hours or less. When the microprocessor 60 determines that the cumulative operating time is 3750 hours or less (Yes in step S131), the microprocessor 60 performs steps S132 to S135 which are the same as steps S13 to S16. When, in step S135, the microprocessor 60 determines that the provisional NOx concentration is 0 ppm or more and 45 ppm or less (Yes in step S135), the microprocessor 60 calculates the pumping current Ip2′ obtained by correcting the pumping current Ip (step S136). The microprocessor 60 calculates the pumping current Ip2′ using the correction expression in Math. 19 below (expression (19)).

$$Ip {2}^{′} = Ip 2 - 1 + \{ ( A 0 \times {H}^{2} + B 0 \times H + C 0 ) \times initial offset + ( D 0 \times {H}^{2} + E 0 \times H + F 0 ) \} \qquad [ Math . 19 ]$$

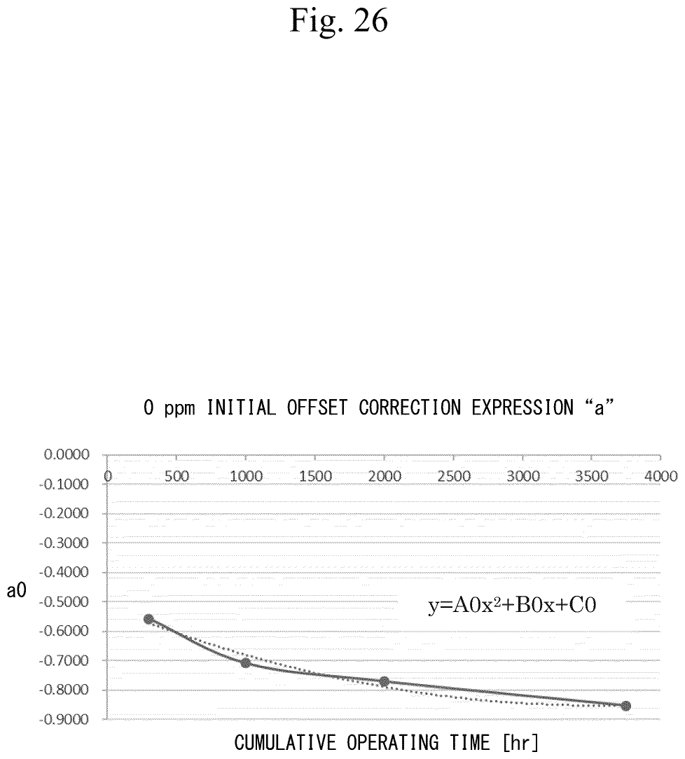

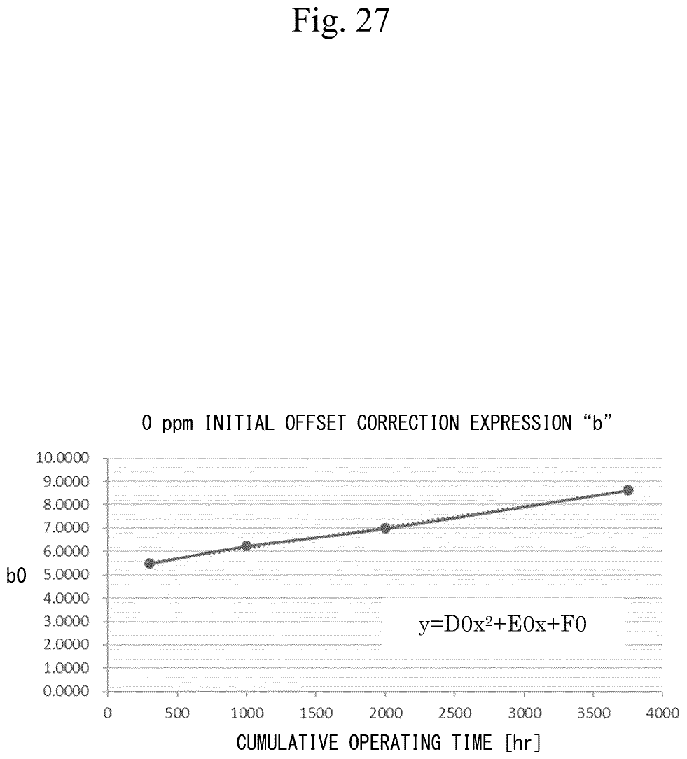

In the microprocessor 60, as the numerical values used for calculating the pumping current Ip2′ (numerical values used in the expressions in Math. 17 to Math. 19), a calculation expression of a gradient a (specifically, a0, a90, a1500) and a calculation expression of an intercept b (specifically, b0, b90, b1500) at each NOx concentration are stored. The gradient a and the intercept b are each a quadratic function defined with a time (cumulative operating time) as a variable. For example, the calculation expression of the gradient a0 when the NOx concentration is 0 ppm is a0=A0×H²+B0×H+C0. The coefficients A0, B0, and C0 are obtained, for example, by approximating the plots with a quadratic expression in a graph showing the correlation between the cumulative operating time and the gradient a0 as shown in FIG. 26. Similarly, the calculation expression of the intercept b0 when the NOx concentration is 0 ppm is b0=D0×H²+E0×H+F0. The coefficients D0, E0, and F0 are obtained, for example, by approximating the plots with a quadratic expression in a graph showing the correlation between the cumulative operating time and the intercept b0 as shown in FIG. 27. In the expression in Math. 19, the gradient a0 and the intercept b0 when the NOx concentration is 0 ppm are used. The quadratic function of the gradient a and the quadratic function of the intercept b are stored, for example, in the microprocessor 60.

The microprocessor 60 calculates the concentration of the specific component (NOx) on the basis of the current value and the quadratic expression defined with the cumulative operating time. Specifically, an appropriate gradient a and an appropriate intercept b corresponding to the cumulative operating time can be obtained by substituting the cumulative operating time into the variable of the quadratic expression. By the expression in Math. 17, the concentration of NOx in the measurement target gas can be calculated using the linear expression including such an appropriate gradient a and such an appropriate intercept b corresponding to the cumulative operating time.

In subsequent step S137, similar to step S18, the microprocessor 60 converts the pumping current Ip2′ into a NOx concentration (hereinafter, referred to as corrected NOx concentration). After step S137, the concentration calculation control is ended.

When, in step S135, the microprocessor 60 determines that the provisional NOx concentration is not 0 ppm or more and 45 ppm or less (greater than 45 ppm) (No in step S135), the microprocessor 60 determines whether or not the provisional NOx concentration is 200 ppm or less (step S138). When, in step S138, the microprocessor 60 determines that the provisional NOx concentration is 200 ppm or less (Yes in step S138), the microprocessor 60 calculates the pumping current Ip2′ obtained by correcting the pumping current Ip (step S139). The microprocessor 60 calculates the pumping current Ip2′ using the correction expression in Math. 20 below (expression (20)).

$$Ip {2}^{′} = Ip 2 \times \frac{1}{\begin{matrix}1 + \{ ( A 90 \times {H}^{2} + B 90 \times H + C 90 ) \times \\ initial offset + ( D90 \times {H}^{2} + E90 \times H + F 90 ) \}\end{matrix}} \qquad [ Math . 20 ]$$

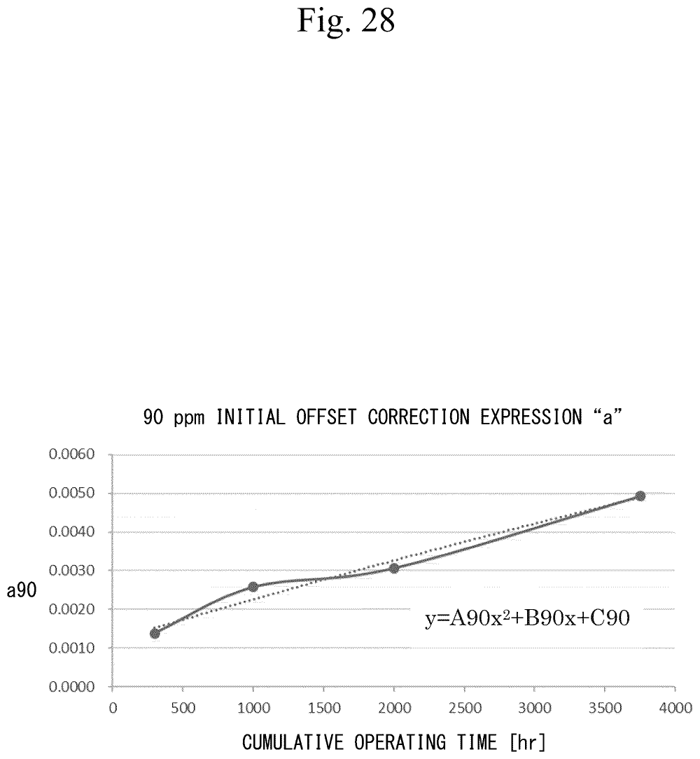

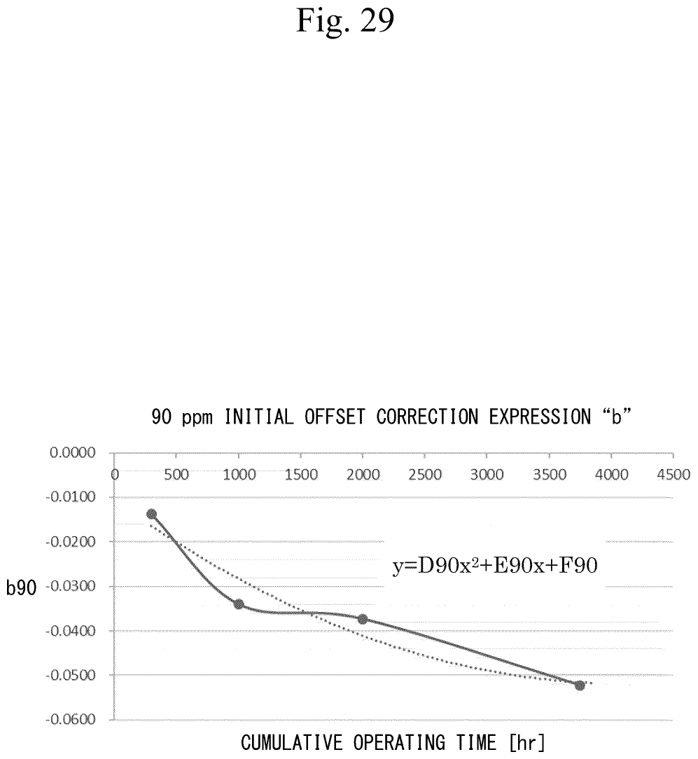

In the expression in Math. 20, the gradient a90 and the intercept b90 when the NOx concentration is 90 ppm are used. For example, the calculation expression of the gradient a90 when the NOx concentration is 90 ppm is a90=A90×H²+B90×H+C90. The coefficients A90, B90, and C90 are obtained, for example, by approximating the plots with a quadratic expression in a graph showing the correlation between the cumulative operating time and the gradient a90 as shown in FIG. 28. Similarly, the calculation expression of the intercept b90 when the NOx concentration is 90 ppm is b0=D90×H²+E90×H+F90. The coefficients D90, E90, and F90 are obtained, for example, by approximating the plots with a quadratic expression in a graph showing the correlation between the cumulative operating time and the intercept b90 as shown in FIG. 29.

When, in step S138, the microprocessor 60 determines that the provisional NOx concentration is not 200 ppm or less (greater than 200 ppm) (No in step S138), the microprocessor 60 calculates the pumping current Ip2′ obtained by correcting the pumping current Ip (step S140). The microprocessor 60 calculates the pumping current Ip2′ using the correction expression in Math. 21 below (expression (21)).

$$Ip {2}^{′} = Ip 2 \times \frac{1}{\begin{matrix}1 + \{ ( A 1500 \times {H}^{2} + B 1500 \times H + C 1500 ) \times \\ Ip 2 decrease ratio + \\ ( D 1500 \times {H}^{2} + B 1500 \times H + F 5100 ) \}\end{matrix}} \qquad [ Math . 21 ]$$

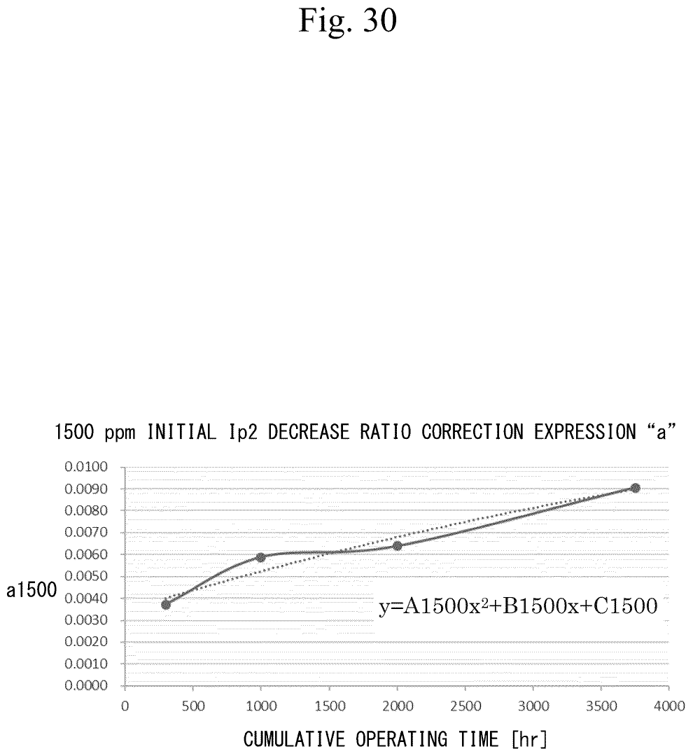

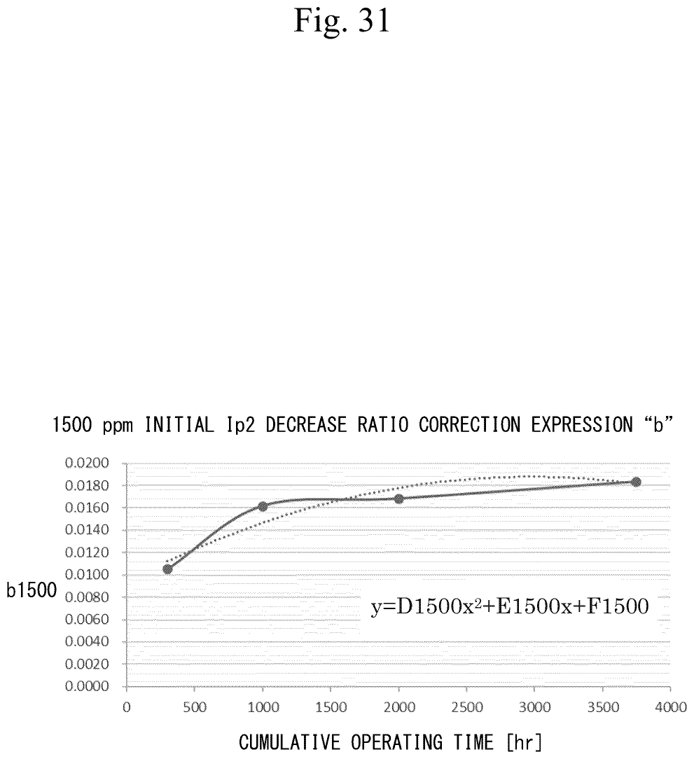

In the expression in Math. 21, the gradient a1500 and the intercept b1500 when the NOx concentration is 1500 ppm are used. For example, the calculation expression of the gradient a1500 when the NOx concentration is 1500 ppm is a1500=A1500×H²+B1500×H+C1500. The coefficients A1500, B1500, and C1500 are obtained, for example, by approximating the plots with a quadratic expression in a graph showing the correlation between the cumulative operating time and the gradient a1500 as shown in FIG. 30. Similarly, the calculation expression of the intercept b1500 when the NOx concentration is 1500 ppm is b1500=D1500×H²+E1500×H+F1500. The coefficients D1500, E1500, and F1500 are obtained, for example, by approximating the plots with a quadratic expression in a graph showing the correlation between the cumulative operating time and the intercept b1500 as shown in FIG. 31.

After step S139 or S140, in step S137, similar to step S18, the microprocessor 60 converts the pumping current Ip2′ into a NOx concentration (hereinafter, referred to as corrected NOx concentration). After step S137, the concentration calculation control is ended.

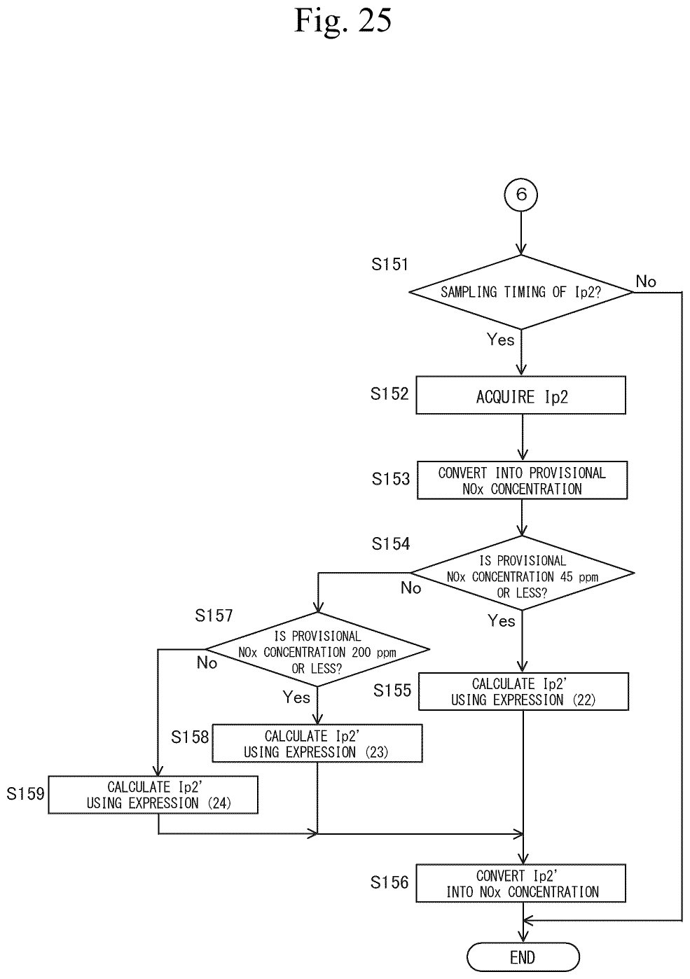

When, in step S131, the microprocessor 60 determines that the cumulative operating time is not 3750 hours or less (greater than 3750 hours) (No in step S131), the microprocessor 60 performs steps S151 to S159 shown in FIG. 25, similar to steps S91 to S99 of the first embodiment. In step S155, the microprocessor 60 calculates the pumping current Ip2′ using the expression in Math. 22 below. The expression in Math. 22 (expression (22)) is the same as the expression in Math. 13 of the first embodiment, and the detailed description thereof is omitted.

$$Ip {2}^{′} = Ip 2 - ( α {0}_{3750} \times initial offset + b {0}_{3750} ) \qquad [ Math . 23 ]$$

In step S158, the microprocessor 60 calculates the pumping current Ip2′ using the correction expression in Math. 23 below (expression (23)). The expression in Math. 23 is the same as the expression in Math. 14 of the first embodiment, and the detailed description thereof is omitted.

$$Ip {2}^{′} = Ip 2 \times \frac{1}{1 + ( α {90}_{3750} \times initial offset + b {90}_{3750} )} \qquad [ Math . 23 ]$$

In step S159, the microprocessor 60 calculates the pumping current Ip2′ using the correction expression in Math. 24 below (expression (24)). The expression in Math. 24 is the same as the expression in Math. 15 of the first embodiment, and the detailed description thereof is omitted.

$$Ip {2}^{′} = Ip 2 \times \frac{1}{1 + ( α {1500}_{3750} \times Ip 2 decrease ratio + b {1500}_{3750} )} \qquad [ Math . 24 ]$$

### 2-2. Advantageous Effects of Second Embodiment

In the second embodiment, the microprocessor 60 calculates the concentration of NOx in the measurement target gas using the quadratic expressions defined with the cumulative operating time. Therefore, an appropriate gradient a and an appropriate intercept b corresponding to the cumulative operating time can be obtained by using the cumulative operating time as the variable of each quadratic expression. The NOx concentration in the measurement target gas can be corrected using the linear expression including such an appropriate gradient a and such an appropriate intercept b corresponding to the cumulative operating time. In addition, in the second embodiment, when the cumulative operating time is greater than 300 hours and 3750 hours or less, one type of calculation expression is used for each concentration segment, so that the continuity of the calculation result (Ip2′) with respect to time change can be maintained as compared to the configuration, as in the first embodiment, in which the calculation expression is changed for each of the time segments.

### 3. Third Embodiment

A gas sensor system of a third embodiment is mainly different from the first embodiment in that only one type of expression is used as a calculation expression of Ip2′ for each concentration segment when the cumulative operating time is 3750 hours or less, and other points are in common with the first embodiment. The same components as those of the first embodiment are designated by the same reference numerals, and the detailed description thereof is omitted.

### 3-1. Concentration Calculation Control of Gas Sensor Control Device 100

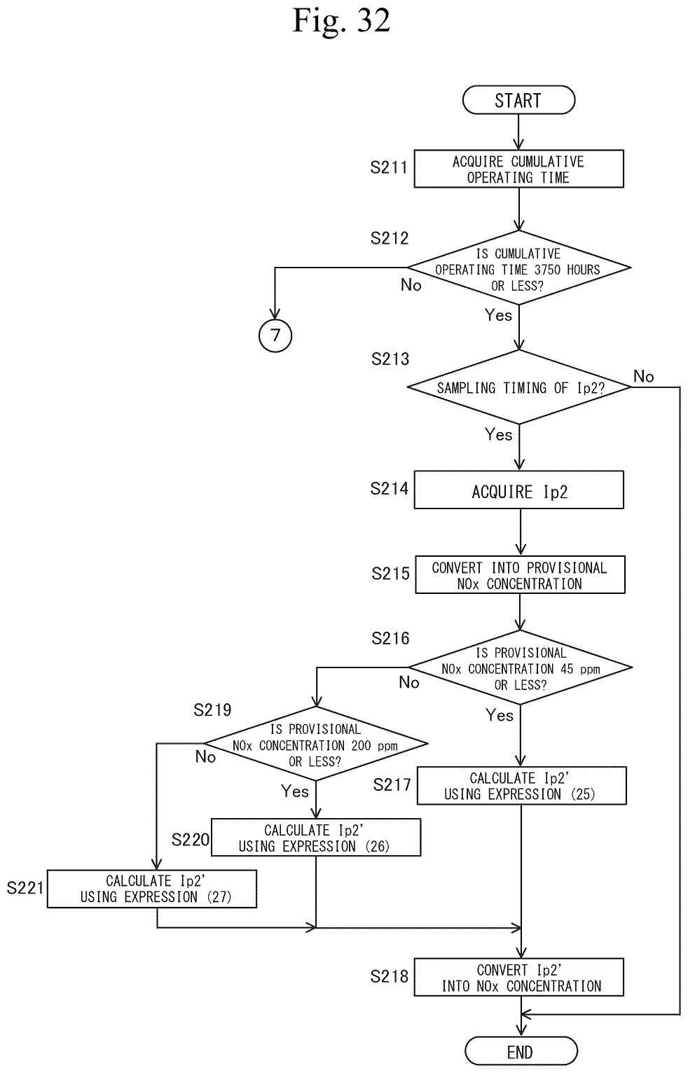

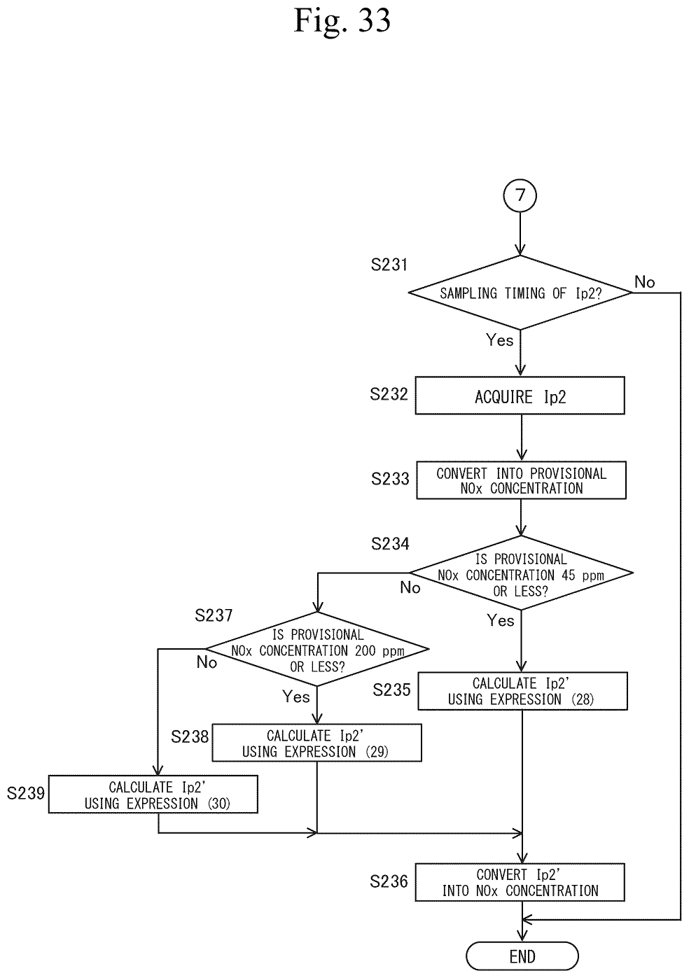

FIG. 32 and FIG. 33 show an example of concentration calculation control performed by the gas sensor control device 100 of the third embodiment. Similar to the concentration calculation control of the first embodiment, the concentration calculation control in FIG. 32 and FIG. 33 is started when a predetermined start condition is satisfied.

Similar to step S11 of the first embodiment, the microprocessor 60 acquires a cumulative operating time (step S211). In subsequent step S212, the microprocessor 60 determines whether or not the cumulative operating time is 3750 hours or less. When, in step S212, the microprocessor 60 determines that the cumulative operating time is 3750 hours or less, the microprocessor 60 performs steps S213 to S216, similar to steps S13 to S16 of the first embodiment. In subsequent step S217, the microprocessor 60 calculates the pumping current Ip2′ using a correction expression in Math. 25 below (expression (25)).

$$Ip {2}^{′} = Ip 2 - ( α {0}_{3750} \times initial offset + b {0}_{3750} ) \times \frac{H}{3750} \qquad [ Math . 25 ]$$

In the expression in Math. 25, a linear expression (a0₃₇₅₀+initial offset+b0₃₇₅₀) with an index at a predetermined reference time (3750 hours) as a variable is multiplied by the ratio (H/3750) of a cumulative operating time H to the predetermined reference time (e.g., 3750 hours). Accordingly, the concentration of NOx in the measurement target gas can be calculated such that the ratio of the predetermined reference time to the cumulative operating time is reflected therein. In addition, since only one type of expression (expression in Math. 25) is used for the same NOx concentration when the cumulative operating time is 3750 hours or less, preliminary acquisition of data for the concentration calculation control can be minimized. That is, data other than a0₃₇₅₀, b0₃₇₅₀, a90₃₇₅₀, b90₃₇₅₀, a1500₃₇₅₀, and b1500₃₇₅₀ shown in FIG. 10 becomes unnecessary.

After step S217, in step S218, similar to step S18 of the first embodiment, the microprocessor 60 converts the pumping current Ip2′ into a NOx concentration (hereinafter, referred to as corrected NOx concentration). After step S218, the concentration calculation control is ended.

When, in step S216, the microprocessor 60 determines that the provisional NOx concentration is not 45 ppm or less (greater than 45 ppm), the microprocessor 60 determines in step S219 whether or not the provisional NOx concentration is 200 ppm or less. When, in step S219, the microprocessor 60 determines that the provisional NOx concentration is 200 ppm or less, the microprocessor 60 calculates the pumping current Ip2′ using a correction expression in Math. 26 below (expression (26)) (step S220).

$$Ip {2}^{′} = Ip 2 \times \frac{1}{1 + ( α {90}_{3750} \times initial offset + b {90}_{3750} ) \times \frac{H}{3750}} \qquad [ Math . 26 ]$$

In the expression in Math. 26, a linear expression with an index at the predetermined reference time (3750 hours) as a variable is used, and similar to the expression in Math. 25, the concentration of NOx in the measurement target gas can be calculated such that the ratio of the predetermined reference time to the cumulative operating time is reflected therein. In addition, since only one type of expression (expression in Math. 26) is used for the same NOx concentration when the cumulative operating time is 3750 hours or less, preliminary acquisition of data for the concentration calculation control can be minimized.

When, in step S219, the microprocessor 60 determines that the provisional NOx concentration is not 200 ppm or less (greater than 200 ppm), the microprocessor 60 calculates the pumping current Ip2′ using a correction expression in Math. 27 below (expression (27)) (step S221).

$$Ip {2}^{′} = \qquad [ Math . 27 ]$$

$$Ip 2 \times \frac{1}{1 + ( α {1500}_{3750} \times Ip 2 decrease ratio + b {1500}_{3750} ) \times \frac{H}{3750}}$$

In the expression in Math. 27, a linear expression with an index at the predetermined reference time (3750 hours) as a variable is used, and similar to the expression in Math. 25, the concentration of NOx in the measurement target gas can be calculated such that the ratio of the predetermined reference time to the cumulative operating time is reflected therein. In addition, since only one type of expression (expression in Math. 27) is used for the same NOx concentration when the cumulative operating time is 3750 hours or less, preliminary acquisition of data for the concentration calculation control can be minimized.

After step S220 or S221, in step S218, similar to step S18 of the first embodiment, the microprocessor 60 converts the pumping current Ip2′ into a NOx concentration (hereinafter, referred to as corrected NOx concentration). After step S218, the concentration calculation control is ended.

When, in step S212, the microprocessor 60 determines that the cumulative operating time is not 3750 hours or less (greater than 3750 hours) (No in step S212), the microprocessor 60 performs steps S231 to S239 shown in FIG. 33, similar to steps S91 to S99 of the first embodiment. In step S235, the microprocessor 60 calculates the pumping current Ip2′ using a correction expression in Math. 28 below (expression (28)). The expression in Math. 28 is the same as the expression in Math. 13 of the first embodiment, and the detailed description thereof is omitted.

$$Ip {2}^{′} = Ip 2 - ( α {0}_{3750} \times initial offset + b {0}_{3750} ) \qquad [ Math . 28 ]$$

In step S238, the microprocessor 60 calculates the pumping current Ip2′ using a correction expression in Math. 29 below (expression (29)). The expression in Math. 29 is the same as the expression in Math. 14 of the first embodiment, and the detailed description thereof is omitted.

$$Ip {2}^{′} = Ip 2 \times \frac{1}{1 + ( α {90}_{3750} \times initial offset + b {90}_{3750} )} \qquad [ Math . 29 ]$$

In step S239, the microprocessor 60 calculates the pumping current Ip2′ using a correction expression in Math. 30 (expression (30)) below. The expression in Math. 30 is the same as the expression in Math. 15 of the first embodiment, and the detailed description thereof is omitted.

$$Ip {2}^{′} = Ip 2 \times \frac{1}{1 + ( α {1500}_{3750} \times Ip 2 decrease ratio + b {1500}_{3750} )} \qquad [ Math . 30 ]$$

### 3-2. Advantageous Effects of Third Embodiment

In the third embodiment, the microprocessor 60 calculates the concentration of NOx in the measurement target gas using the linear expression with an index at the predetermined reference time as a variable, and the ratio of the predetermined reference time to the cumulative operating time. Accordingly, the concentration of NOx in the measurement target gas can be calculated such that the ratio of the predetermined reference time to the cumulative operating time is reflected therein.

### Other Embodiments

The present invention is not limited to the embodiments described by the above description and the drawings, and, for example, the following embodiments are also included in the technical scope of the present invention. In addition, various features of the above-described embodiments and the embodiments described below may be combined in any manner as long as the combination is not contradictory.

In the above first to third embodiments, the NOx sensor 20 is illustrated as an example of the gas sensor, but the gas sensor may be a gas sensor that detects the concentration of another specific component (component other than NOx) in the measurement target gas.

In the above first to third embodiments, the Ip2 detection circuit 55 detects the pumping current generated in the second pumping cell 113, but the Ip2 detection circuit 55 may not necessarily be provided. In this case, for example, the microprocessor 60 may grasp the pumping current (current flowing through the second pumping cell 113).

In the above first to third embodiments, the microprocessor 60 stores a plurality of patterns of a linear expression in association with the predetermined concentration segments of the NOx concentration corresponding to the current value, but a plurality of patterns of a linear expression may be stored so as to be directly associated with the current value.

In the above first to third embodiments, the first reference time (reference time for the initial offset), the second reference time (reference time for the initial Ip2 decrease ratio), and the third reference time (reference time for the cumulative operating time) are the same, but some or all of these reference times may be different from each other.

In the above first to third embodiments, either the initial offset or the initial Ip2 decrease ratio is used in each of the correction expressions in Math. 1 to Math. 30, but both the initial offset and the initial Ip2 decrease ratio may be used.

In the above first to third embodiments, as for the NOx concentration detected on the upstream side with respect to the exhaust gas purifying device 3 (location where the NOx concentration is relatively high), the NOx concentration in the measurement target gas is calculated such that the initial Ip2 decrease ratio is reflected therein, and as for the NOx concentration detected on the downstream side with respect to the exhaust gas purifying device 3 (location where the NOx concentration is relatively low), the NOx concentration in the measurement target gas is calculated such that the initial offset is reflected therein. However, only the NOx concentration detected on either the upstream side or the downstream side may be corrected.

In the above first to third embodiments, the initial Ip2 decrease ratio is used in the calculation expressions of Ip2′ when the magnitude of the pumping current is in the predetermined high-current state, and the initial offset is used in the calculation expressions of Ip2′ when the magnitude of the pumping current is in the predetermined low-current state. However, there may be another current state between the high-current state and the low-current state (state where a current lower than that in the high-current state flows, and a current higher than that in the low-current state flows), and in this current state, at least either the initial Ip2 decrease ratio or the initial offset may be used in the calculation expressions of Ip2′.

In the above first to third embodiments, the initial offsets, the initial Ip2 decrease ratios, and the linear expressions used for correcting the NOx concentration are stored in the microprocessor 60, but may be stored in another memory such as the ECU 90.

The embodiments disclosed herein are merely illustrative in all aspects and should not be recognized as being restrictive. The scope of the present invention is not limited to the embodiments disclosed herein, and is intended to include all modifications within the scope defined by the claims or the scope of the equivalents to the claims.

### DESCRIPTION OF REFERENCE NUMERALS

1: gas sensor system (gas sensor control system)
2: internal combustion engine
3: exhaust gas purifying device
20: NOx sensor (gas sensor)
55: Ip2 detection circuit
60: microprocessor (calculation unit, storage unit)
100: gas sensor control device (NOx sensor control device)
111: first pumping cell
113: second pumping cell
145: second-pump first electrode (electrode)
147: second-pump second electrode (electrode)
MR1: first measurement chamber (measurement chamber)
MR2: second measurement chamber (measurement chamber)

What is claimed is:

1. A gas sensor control device for controlling a gas sensor having therein a measurement chamber to which an external measurement target gas is introduced, the gas sensor including
a first pumping cell configured to perform pumping-out and pumping-in of oxygen with respect to the measurement target gas in the measurement chamber, and
a second pumping cell having a pair of electrodes disposed inside and outside the measurement chamber, respectively, and configured to output a current between the pair of electrodes in accordance with a concentration of a specific component in the measurement target gas that has been introduced into the measurement chamber and on which the pumping-out and the pumping-in of oxygen have been performed, the gas sensor control device comprising
a calculation unit configured to calculate the concentration of the specific component from a current value which is a magnitude of the current, wherein
when calculating the concentration of the specific component, the calculation unit performs correction on the basis of an index including at least either an initial offset indicating the current value when the concentration of the specific component at a first reference time is 0 or a difference between an ideal value and the current value when the concentration of the specific component at a second reference time is a set concentration, and a cumulative operating time which is a total operating time of the gas sensor from a third reference time.

2. The gas sensor control device according to claim 1, wherein
when the current value is in a predetermined high-current state, the calculation unit calculates the concentration of the specific component using the difference as the index, and
when the current value is in a predetermined low-current state, the calculation unit calculates the concentration of the specific component using the initial offset as the index.

3. The gas sensor control device according to claim 1, further comprising a storage unit configured to divide the cumulative operating time into a plurality of predetermined time segments, divide the current value into a plurality of predetermined current value segments, divide a concentration of the specific component corresponding to the current value into a plurality of predetermined concentration segments, and store a plurality of patterns of a linear expression with the initial offset or the difference as a variable in association with at least one of the predetermined time segments, the predetermined current value segments, or the predetermined concentration segments, wherein
the calculation unit selects the linear expression stored in the storage unit, on the basis of at least one of the predetermined time segments, the predetermined current value segments, or the predetermined concentration segments, and calculates the concentration of the specific component on the basis of the current value and the linear expression selected from among the plurality of patterns stored in the storage unit and corresponding to the cumulative operating time, the current value, or a concentration corresponding to the current value.

4. The gas sensor control device according to claim 1, further comprising a storage unit configured to divide the cumulative operating time into a plurality of predetermined time segments, divide the current value into a plurality of predetermined current value segments, divide a concentration of the specific component corresponding to the current value into a plurality of predetermined concentration segments, and store a plurality of patterns of a linear expression with the initial offset or the difference as a variable in association with at least one of the predetermined time segments, the predetermined current value segments, or the predetermined concentration segments, wherein
the storage unit stores a quadratic expression defined with a time as a variable, as each of a gradient and an intercept of the linear expression, and
the calculation unit calculates the concentration of the specific component on the basis of the current value and the quadratic expression defined with the cumulative operating time.

5. The gas sensor control device according to claim 1, further comprising a storage unit configured to store a linear expression with the index at a predetermined reference time as a variable, wherein
the calculation unit calculates the concentration of the specific component on the basis of the linear expression and a ratio of the cumulative operating time to the predetermined reference time.

6. A gas sensor control method for controlling a gas sensor having therein a measurement chamber to which an external measurement target gas is introduced, the gas sensor including
a first pumping cell configured to perform pumping-out and pumping-in of oxygen with respect to the measurement target gas in the measurement chamber, and
a second pumping cell having a pair of electrodes disposed inside and outside the measurement chamber, respectively, and configured to output a current between the pair of electrodes in accordance with a concentration of a specific component in the measurement target gas that has been introduced into the measurement chamber and on which the pumping-out and the pumping-in of oxygen have been performed, the gas sensor control method comprising
when calculating the concentration of the specific component from a current value which is a magnitude of the current, performing correction on the basis of an index including at least either an initial offset indicating the current value when the concentration of the specific component at a first reference time is 0 or a difference between an ideal value and the current value when the concentration of the specific component at a second reference time is a set concentration, and a cumulative operating time which is a total operating time of the gas sensor from a third reference time.

7. A gas sensor control system comprising the gas sensor control device according to claim 1, and the gas sensor.

8. The gas sensor control system according to claim 7, wherein
the measurement target gas is an exhaust gas discharged from an internal combustion engine to which an exhaust gas purifying device configured to purify an exhaust gas is attached,
the gas sensor detects the concentration of the specific component on an upstream side with respect to the exhaust gas purifying device, and
the calculation unit calculates the concentration of the specific component using the difference as the index.

9. The gas sensor control system according to claim 7, wherein
the measurement target gas is an exhaust gas discharged from an internal combustion engine to which an exhaust gas purifying device configured to purify an exhaust gas is attached,
the gas sensor detects the concentration of the specific component on a downstream side with respect to the exhaust gas purifying device, and
the calculation unit calculates the concentration of the specific component using the initial offset as the index.

10. The gas sensor control device according to claim 2, further comprising a storage unit configured to divide the cumulative operating time into a plurality of predetermined time segments, divide the current value into a plurality of predetermined current value segments, divide a concentration of the specific component corresponding to the current value into a plurality of predetermined concentration segments, and store a plurality of patterns of a linear expression with the initial offset or the difference as a variable in association with at least one of the predetermined time segments, the predetermined current value segments, or the predetermined concentration segments, wherein
the calculation unit selects the linear expression stored in the storage unit, on the basis of at least one of the predetermined time segments, the predetermined current value segments, or the predetermined concentration segments, and calculates the concentration of the specific component on the basis of the current value and the linear expression selected from among the plurality of patterns stored in the storage unit and corresponding to the cumulative operating time, the current value, or a concentration corresponding to the current value.

11. The gas sensor control device according to claim 2, further comprising a storage unit configured to divide the cumulative operating time into a plurality of predetermined time segments, divide the current value into a plurality of predetermined current value segments, divide a concentration of the specific component corresponding to the current value into a plurality of predetermined concentration segments, and store a plurality of patterns of a linear expression with the initial offset or the difference as a variable in association with at least one of the predetermined time segments, the predetermined current value segments, or the predetermined concentration segments, wherein
the storage unit stores a quadratic expression defined with a time as a variable, as each of a gradient and an intercept of the linear expression, and
the calculation unit calculates the concentration of the specific component on the basis of the current value and the quadratic expression defined with the cumulative operating time.

12. The gas sensor control device according to claim 2, further comprising a storage unit configured to store a linear expression with the index at a predetermined reference time as a variable, wherein
the calculation unit calculates the concentration of the specific component on the basis of the linear expression and a ratio of the cumulative operating time to the predetermined reference time.
